(19) United States
(12) Patent Application Publication
(10) Pub. No.: US 2021/0152564 A1
(43) Pub. Date: May 20, 2021

(54) SOUND WAVE COMMUNICATION PLATFORM, COMMUNICATION METHOD USING SOUND WAVE SIGNAL, AND DEVICE THEREFOR

(71) Applicant: MOBIDOO CO.,LTD., Seoul (KR)

(72) Inventor: David Yun Hee LEE, Seoul (KR)

(73) Assignee: MOBIDOO CO.,LTD., Seoul (KR)

(21) Appl. No.: 16/492,157

(22) PCT Filed: Sep. 3, 2018
(86) PCT No.: PCT/KR2018/010213

§ 371 Date: Sep. 9, 2019

(30) Foreign Application Priority Data
Nov. 24, 2017 (KR) 10-2017-0158447
Nov. 24, 2017 (KR) 10-2017-0158491

(51) Int. Cl. H04L 29/06; G10L 25/51; H04B 11/00; G06F 11/10

(52) U.S. Cl. CPC H04L 63/126; G10L 25/51; G06Q 30/0225; G06F 11/10; H04B 11/00

(57) ABSTRACT

An operating method of a service server is disclosed. In one embodiment, the method: transmits a security key to a terminal; receives, from the other terminal, payload data and symbol request data including service type information; generates a symbol corresponding to the other terminal according to a size determined on the basis of the service type information; generates, for the other terminal, mapping information in which the payload data and the generated symbol are mapped; generates sound wave data for outputting a sound wave of the other terminal on the basis of the generated symbol; transmits the generated sound wave data to the other terminal; receives, from the terminal, payload request data and the sound wave recognition result generated on the basis of the security key and the sound wave, wherein the sound wave is outputted on the basis of sound wave data received by the other terminal from the service server; confirms whether the sound wave recognition result and the generated symbol match; and, if matching, transmits the payload data to the terminal on the basis of the mapping information.

### TECHNICAL FIELD

Example embodiments relate to a sound wave communication platform, a communication method using a sound wave signal, and a device therefor.

### BACKGROUND ART

Recently, a communication method using a sound wave has been used in various fields. Since a sound wave is propagated in a space, a third party may receive and process the sound wave. To prevent such third party processing, various methods have been studied.

In a related art, Korean Patent Publication No. 10-1645175 (Title: Sonic Wave Communication System, Applicant: NANOSOFT) discloses a sonic wave communication system including a sound wave receiver that receives a sound wave signal output from a sound wave receiver and analyzes the receives sound wave signal.

### DISCLOSURE OF INVENTION

### Technical Solutions

According to an aspect, there is provided an operation method of a service server, the method including transmitting a security key to a terminal and receiving payload data and symbol request data including service type information from another terminal, generating a symbol corresponding to the other terminal based on a size determined based on the service type information, generating mapping information in which the payload data and the generated symbol are mapped, with respect to the other terminal, generating sound wave data for outputting a sound wave of the other terminal based on the generated symbol, transmitting the generated sound wave data to the other terminal, receiving, from the terminal, payload request data and a sound wave recognition result generated based on a sound wave and the security key, the sound wave being output by the other terminal based on sound wave data received from the service server, verifying whether the sound wave recognition result matches the generated symbol, and transmitting, in response to the matching, the payload data to the terminal based on the mapping information.

The generated sound wave data may include the generated symbol and an error correction code.

An arrangement of bits of the generated symbol and the error correction code may be changed based on the security key.

The operation method may further include setting a frequency post of each of bits of the generated sound wave data based on at least one of frequency interval information and starting frequency information.

The frequency interval information and the starting frequency information may be associated with the service type information.

When the sound wave data is generated, the operation method may further include setting a frequency post of each of bits of the generated sound wave data, generating a sound wave tone for a frequency post having a bit value of 1 among the bits, generating a multi-tone sound wave through an aggregation of the generated sound wave tone, and generating a playback file in which the multi-tone sound wave is recorded.

The operation method may further include verifying a validity of the sound wave recognition result by verifying whether the sound wave recognition result is received within a predetermined time from a point in time at which the symbol is generated.

The operation method may further include receiving confirmation request data indicating whether the terminal receives the payload data from the other terminal and transmitting response data indicating whether reception of the payload data is completed by the terminal to the other terminal.

The operation method may further include generating additional mapping information by mapping payload data of the terminal to the mapping information when the service server additionally receives the payload data of the terminal from the terminal while receiving the sound wave recognition result and the payload request data, and transmitting the payload data to the other terminal based on the additional mapping information when request data associated with the payload data of the terminal is received from the other terminal.

The payload data may include at least one of uniform resource locator (URL) information, a text, a static image, and a dynamic image.

According to another aspect, there is also provided a service server including a communication interface and a controller coupled to the communication interface, wherein the controller is configured to transmit a security key to a terminal and receive payload data and symbol request data including service type information from another terminal through the communication interface, generate a symbol corresponding to the other terminal based on a size determined based on the service type information, generate mapping information in which the payload data and the generated symbol are mapped, with respect to the other terminal, generate sound wave data for outputting a sound wave of the other terminal based on the generated symbol, transmit the generated sound wave data to the other terminal through the communication interface, receive payload request data and a sound wave recognition result generated based on a sound wave and the security key from the terminal through the communication interface, the sound wave being output by the other terminal based on sound wave data received from the service server, verify whether the sound wave recognition result matches the generated symbol, and transmit, in response to the matching, the payload data to the terminal based on the mapping information.

The generated sound wave data may include the generated symbol and an error correction code.

An arrangement of bits of the generated symbol and the error correction code may be changed based on the security key.

The controller may be configured to set a frequency post of each of bits of the generated sound wave data based on at least one of frequency interval information and starting frequency information.

The frequency interval information and the starting frequency information may be associated with the service type information.

When the sound wave data is generated, the controller may be configured to set a frequency post of each of bits of the generated sound wave data, generate a sound wave tone for a frequency post having a bit value of 1 among the bits, generate a multi-tone sound wave through an aggregation of the generated sound wave tone, generate a playback file in which the multi-tone sound wave is recorded, and transmit the playback file to the other terminal through the communication interface.

The controller may be configured to verify a validity of the sound wave recognition result by verifying whether the sound wave recognition result is received within a predetermined time from a point in time at which the symbol is generated.

The controller may be configured to receive confirmation request data indicating whether the terminal receives the payload data from the other terminal and transmit response data indicating whether reception of the payload data is completed by the terminal to the other terminal.

The controller may be configured to generate additional mapping information by mapping payload data of the terminal to the mapping information when the service server additionally receives the payload data of the terminal from the terminal while receiving the sound wave recognition result and the payload request data, and transmit the payload data to the other terminal based on the additional mapping information when request data associated with the payload data of the terminal is received from the other terminal.

The payload data may include at least one of URL information, a text, a static image, and a dynamic image.

According to another aspect, there is also provided a communication method using a sound wave signal, the method including processing, by a sound wave processing device, source data by arranging m bits included in the source data based on a shuffle array used as a security code, encoding the processed source data to a sound wave signal, and outputting the encoded sound wave signal, wherein the encoding includes setting m frequency posts corresponding to the m bits based on service type information and generating a sound wave tone having a predetermined amplitude for each of the m frequency posts and generating a multi-tone sound wave signal through an aggregation of the sound wave tone.

A position of an initial frequency post among the m frequency posts may be set based on the service type information.

A minimum frequency interval between the m frequency posts may be differently set based on the service type information.

A frequency interval between the m frequency posts may be uniform.

A frequency interval between the m frequency posts may be non-uniform.

The sound wave tone may be generated in the frequency post corresponding to a bit “1” of the source data.

The source data may include a body and an error correction code.

The source data may further include a time code associated with a time in which the sound wave signal is generated. The time code may be information for determining whether the sound wave signal is valid.

According to another aspect, there is also provided sound wave processing device including a memory in which a control program is recorded, a processor configured to operate based on the control program, and a communication interface configured to transmit and receive information to and from an external server, wherein the control program is executed to perform processing source data by arranging m bits included in the source data based on a shuffle array used as a security code by the sound wave processing device, encoding the processed source data to a sound wave signal, and outputting the encoded sound wave signal and wherein the encoding includes setting m frequency posts corresponding to the m bits based on service type information and generating a sound wave tone having a predetermined amplitude for each of the m frequency posts and generating a multi-tone sound wave signal through an aggregation of the sound wave tone.

A position of an initial frequency post among the m frequency posts may be set based on the service type information.

A minimum frequency interval between the m frequency posts is differently set based on the service type information.

A frequency interval between the m frequency posts may be uniform.

A frequency interval between the m frequency posts may be non-uniform.

The shuffle array may be changed based on a predetermined time period.

The sound wave tone is generated in the frequency post corresponding to a bit “1” of the source data.

The source data may include a body and an error correction code.

The source data may further include a time code associated with a time in which the sound wave signal is generated. The time code may be information for determining whether the sound wave signal is valid.

### Effects

In typical sound wave communication, due to a limited sound wave frequency, it may be difficult to achieve a sufficiently high transmission rate and transmit a large amount of data such as image, video, or text information in a form of sound wave. In addition, the typical sound wave communication may be vulnerable to security since a third party may record and analyze sound waves. Also, when various applications are executed, an interference may occur in the sound wave communication.

According to example embodiments, it is possible to provide a service that may send a large amount of data to a user at a high speed using a sound wave communication platform. In addition, it is possible to provide security-enhanced sound wave communication to be used in various applications. Also, the interference may be minimized in various applications.

### BRIEF DESCRIPTION OF DRAWINGS

FIG. 1 is a diagram illustrating a sound wave communication platform according to an example embodiment.

FIG. 2 is a flowchart illustrating an example of an operation of a sound wave communication platform according to an example embodiment.

FIG. 3 is a diagram illustrating sound wave data according to an example embodiment.

FIG. 4A is a diagram illustrating an encoding of sound wave data according to an example embodiment.

FIG. 4B is a diagram illustrating a multi-tone sound wave according to an example embodiment.

FIGS. 5 and 6 are diagrams illustrating another example of an operation of a sound wave communication platform according to an example embodiment.

FIGS. 7 and 8 are diagrams illustrating a case in which an amount of sound wave data of a sound wave communication platform is relatively large according to an example embodiment.

FIG. 9 is a diagram illustrating another example of an operation of a sound wave communication platform according to an example embodiment.

FIGS. 10 and 11 are diagrams illustrating another example of an operation of a sound wave communication platform according to an example embodiment.

FIG. 12 is a block diagram illustrating a service server of a sound wave communication platform according to an example embodiment.

FIG. 13 is a diagram illustrating a communication method using a sound wave signal according to an example embodiment.

FIG. 14 is a flowchart illustrating a communication method using a sound wave signal according to an example embodiment.

FIGS. 15A and 15B are block diagrams illustrating a sound wave protocol used for sound wave communication according to an example embodiment.

FIG. 16 illustrates a frequency used for sound wave communication and a sound wave tone of the frequency according to an example embodiment.

FIG. 17 illustrates a security algorithm of sound wave communication according to an example embodiment.

FIGS. 18A and 18B illustrate a change in position of a frequency post based on a security algorithm according to an example embodiment.

FIG. 19 illustrates an example of a sound wave protocol for transmitting a large amount of source data according to an example embodiment.

FIG. 20 illustrates another example of a sound wave protocol for transmitting a large amount of source data according to an example embodiment.

FIG. 21 illustrates an example of a sound wave communication method additionally using an external server according to an example embodiment.

FIG. 22 illustrates another example of a sound wave communication method additionally using an external server according to an example embodiment.

FIG. 23 is a block diagram illustrating a sound wave processing device according to an example embodiment.

### BEST MODE FOR CARRYING OUT THE INVENTION

Hereinafter, example embodiments will be described in detail with reference to the accompanying drawings.

It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

<Sound Wave Communication Platform>

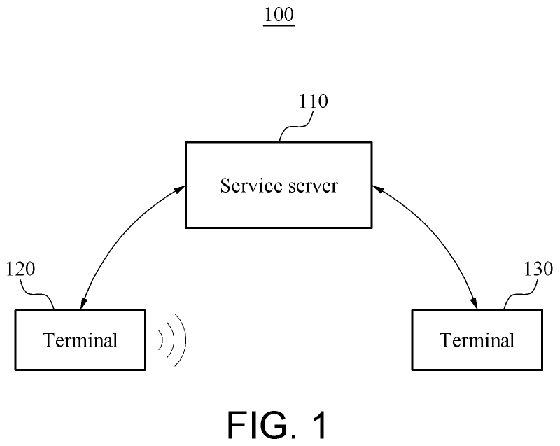

FIG. 1 is a diagram illustrating a sound wave communication platform according to an example embodiment.

Referring to FIG. 1, a sound wave communication platform 100 includes a service server 110 and terminals 120 and 130. The sound wave communication platform 100 may also be referred to as a sound wave communication system.

The service server 110 may receive payload data, for example, a text, a static image, or a dynamic image from the terminal 120, generate sound wave data of the terminal 120, and transmit the sound wave data to the terminal 120.

The terminal 120 may generate and output a sound wave based on the sound wave data. For example, the terminal 120 may generate a playback file (e.g., a way file) based on the sound wave data and play the playback file. Also, the terminal 120 may receive the playback file based on the sound wave data from the service server 110 and play the received playback file. The terminal 130 may transmit a sound wave recognition result obtained by recognizing the sound wave of the terminal 120 to the service server 110.

The service server 110 may verify whether the terminal 130 is entitled to use payload data of the terminal 120 based on the sound wave recognition result. Here, when the terminal 130 is entitled to use the payload data of the terminal 120, the service server 110 may transmit the payload data of the terminal 120 to the terminal 130.

Typical sound wave communication may be difficult to transmit a large amount of data due to limitation on a frequency band and may be vulnerable to security. The sound wave communication platform 100 may map a symbol and payload data, thereby efficiently transmitting a large amount of data. Also, the sound wave communication platform 100 manages security to provide enhanced security. For example, the sound wave communication platform 100 may be applied to a payment service, an attendance check service, and an entry service to improve securities of the services, or applied to a marketing service to quickly transmit a coupon image to a user who needs a coupon. In addition to the aforementioned services, the sound wave communication platform 100 may also be applied to transmit data or information owned by a specific user to another user.

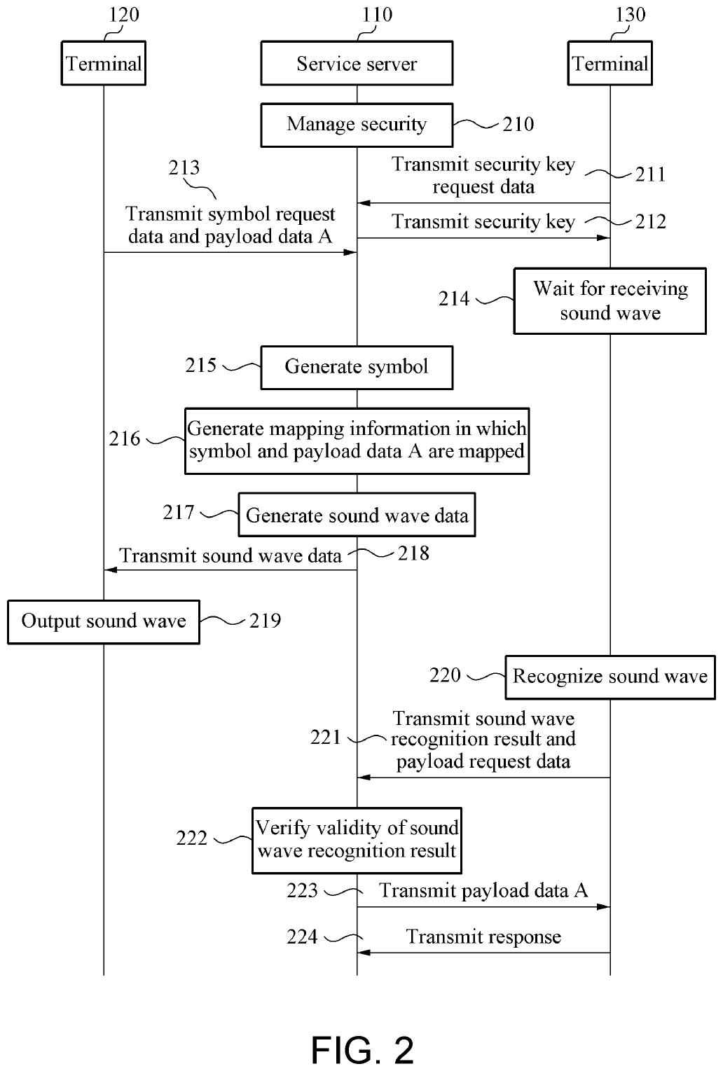

Hereinafter, an example of an operation of the sound wave communication platform 100 will be described in detail with reference to FIG. 2.

<Sound Wave Communication Platform—One-Way Sound Wave-Based One-Way Data Transmission>

FIG. 2 is a flowchart illustrating an example of an operation of a sound wave communication platform according to an example embodiment.

Referring to FIG. 2, in operation 210, the service server 110 may manage security of the sound wave communication platform 100. A security management of the service server 110 may be classified into a sound wave protocol differing based on service type information and a security key used to encode sound wave data. Since the sound wave protocol differs based on the service type information, security of sound wave communication may be more enhanced. Table 1 shows an example of a sound wave protocol for each item of service type information.

TABLE 1

| | | | Sound | Minimum | | | |
|---|---|---|---|---|---|---|---|
| | Symbol | CRC | wave data | frequency | | Starting | |
| | size | size | size | interval | | frequency | |
| Payment | 26 bits to | 8 bits | 34 bits to | 50 | Hz | 18 | kHz |
| | 40 bits | | 48 bits | | | | |
| Attendance | 12 bits | 8 bits | 20 bits | 100 | Hz | 18.5 | kHz |
| Marketing | 12 bits | 8 bits | 20 bits | 100 | Hz | 19 | kHz |
| Entry | 26 bits | 8 bits | 34 bits | 50 | Hz | 19.5 | kHz |

In Table 1, “Attendance” indicates a service related to an attendance authentication for a predetermined place of a user of the terminal 130, “Marketing” indicates a service for marketing to the user of the terminal 130 (e.g., providing a coupon), and “Entry” indicates a service related to an authentication for the user of the terminal 130 to enter a predetermined place.

Depending on an implementation, a sound wave protocol may vary even in a case of the same type of service. In terms of the payment service, there are various types of payment services with various service providers (e.g., SSG pay service provider, L-pay service provider, etc.). The service server 110 may manage sound wave protocols corresponding to the payment services or manage different sound wave protocols for service providers. For example, a sound wave protocol corresponding to a payment service A may be different from a sound wave protocol corresponding to a payment service B. Table 2 shows an example in which different sound wave protocols correspond to the same type of service.

TABLE 2

| | | | Sound | Minimum | | | |
|---|---|---|---|---|---|---|---|
| | Symbol | CRC | wave data | frequency | | Starting | |
| | size | size | size | interval | | frequency | |
| Payment A | 26 bits to | 8 bits | 34 bits to | 50 | Hz | 18 | kHz |
| | 40 bits | | 48 bits | | | | |
| Payment B | 26 bits to | 8 bits | 34 bits to | 50 | Hz | 18.3 | kHz |
| | 40 bits | | 48 bits | | | | |
| . . . | . . . | . . . | . . . | . . . | | . . . | |
| Attendance A | 12 bits | 8 bits | 20 bits | 100 | Hz | 18.5 | kHz |
| Attendance B | 12 bits | 8 bits | 20 bits | 100 | Hz | 18.9 | kHz |
| . . . | . . . | . . . | . . . | . . . | | . . . | |
| Marketing A | 12 bits | 8 bits | 20 bits | 100 | Hz | 19 | kHz |
| Marketing B | 12 bits | 8 bits | 20 bits | 100 | Hz | 19.3 | kHz |
| . . . | . . . | . . . | . . . | . . . | | . . . | |
| Entry A | 26 bits | 8 bits | 34 bits | 50 | Hz | 19.5 | kHz |
| Entry B | 26 bits | 8 bits | 34 bits | 50 | Hz | 19.9 | kHz |

| | | | | | |
|---|---|---|---|---|---|
| . . . | . . . | . . . | . . . | . . . | . . . |

The service server 110 may generate sound wave data based on a sound wave protocol matching service type information and set a frequency post. Related description will be provided later.

The service server 110 may enhance the security by periodically changing a security key. For example, the service server 110 may change the security key at intervals of a day, a week, or two weeks. When relatively high security is required, the service server 110 may change the security key at intervals of a shorter period.

In operation 211, the terminal 130 may transmit security key request data to the service server 110. In other words, the terminal 130 may request the security key from the service server 110. For example, when a predetermined application of the terminal 130 is executed, the terminal 130 may request the security key from the service server 110. Here, the predetermined application may be an application related to a service to be provided to the user of the terminal 130 such as a payment service, a marketing service, an attendance check service, an entry service, and the like, for example.

In operation 212, the service server 110 may transmit the security key to the terminal 130. The terminal 130 may receive the security key from the service server 110. For example, according to a change cycle of the security key, the terminal 130 may receive the security key once a day. However, it is provided as an example only.

In operation 214, when the security key is received from the service server 110, the terminal 130 may enter a sound-wave reception standby state. For example, when the security key is received from the service server 110, the terminal 130 may activate a microphone.

In operation 213, the terminal 120 may transmit symbol request data and payload data A to the service server 110. The symbol request data may include the service type information. For example, when the sound wave communication platform 110 is related to the payment service, the service type information may indicate “payment.” When the sound wave communication platform 110 is related to the attendance check service, the service type information may indicate “attendance.” When the sound wave communication platform 110 is related to the marketing service, the service type information may indicate “marketing.” When the sound wave communication platform 110 is related to the entry service, the service type information may indicate “entry.” Depending on an implementation, “payment A”, “attendance B”, or the like shown in Table 2 may be set in the service type information, so that the service type information is transmitted to the service server 110.

The payload data A may include any one or combinations of, for example, uniform resource locator (URL) information, a file, a text, a static image, and a dynamic image. Also, the payload data A may include information associated with a storage location (e.g., URL) of a file, a static image, or a dynamic image. As an example of the attendance check service, a terminal in a predetermined place (e.g., a lecture room) may transmit the payload data A, that is, lecture attendance information (e.g., a school A, a lecture room B, a professor C, a class D, and time information of the class D). In this example, as will be described below, a student terminal may transmit, to a service server, user information and a sound wave recognition result obtained by recognizing a sound wave output by a terminal in a predetermined place, and then receive attendance authentication information from the service server. As an example of the marketing service, the payload data A may include a coupon, a URL at which a coupon download is available, or a URL at which an event join is available. In this example, a providing terminal (e.g., a PC, a smartphone, a TV, or a speaker capable of outputting a sound wave) may transmit the coupon to a service server. A user terminal may transmit, to the service server, a sound wave recognition result obtained by recognizing the sound wave output by the providing terminal, and then receive the coupon from the service server.

The payload data may also be referred to as contents data.

In operation 215, the service server 110 may generate a symbol A corresponding to the terminal 120 based on a sound wave protocol matching the service type information in the symbol request data. As an example, when the service type information indicates “payment”, the service server 110 may generate 26 bits, that is, the symbol A based on a symbol size of a sound wave protocol corresponding to “payment” of Table 1. As another example, when the service type information indicates “attendance”, the service server 110 may generate the symbol A corresponding to 12 bits based on a symbol size of a sound wave protocol corresponding to “attendance” of Table 1.

The symbol A may indicate, for example, a unique identifier assigned to corresponding sound wave communication of the terminal 120. When the sound wave communication of the terminal 120 is terminated, it can be seen that a validity of the symbol A is expired.

The service server 110 may generate a different symbol every time that a symbol request from the terminal 120 is made. In other words, the service server 110 may randomly determine bits corresponding to a symbol size every time that a symbol request from the terminal 120 is made.

In operation 216, the service server 110 may generate mapping information in which the symbol A and the payload data A are mapped with respect to the terminal 120. In the service server 110, mapping information associated with at least one another terminal may be stored in addition to the mapping information associated with the terminal 120.

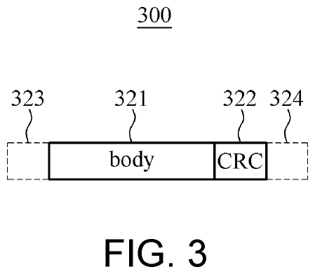

In operation 217, the service server 110 may generate sound wave data based on the symbol A. For example, the service server 110 may generate sound wave data including the symbol A and an error correction code according to the sound wave protocol matching the service type information. FIG. 3 illustrates an example of a format 300 of sound wave data. In the example of FIG. 3, the format 300 may include a body field 321 and a CRC field 322. The symbol A may be set in the body field 321 and the error correction code may be set in the CRC field 322. As described above, since the symbol size may vary based on the service type information, a size of the body field 321 may vary based on the service type information. Depending on an implementation, the format 300 may include a start bit field 323 (size=1) and an end bit field 324 (size=1).

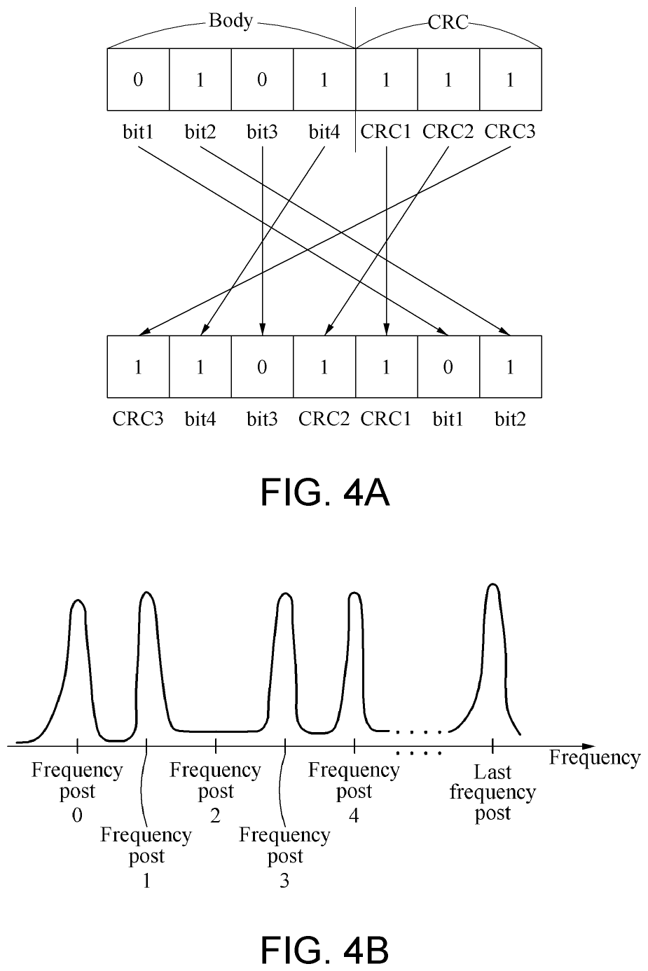

In an example, the service server 110 may encode the sound wave data using a security key. Specifically, the service server 110 may encode the sound wave data by changing an arrangement of bits in the body field 321 and the CRC field 322 using the security key. Referring to an example illustrated in FIG. 4A, the service server 110 may change or shuffle bit 1, bit 2, bit 3, bit 4, CRC 1, CRC 2, CRC 3 to CRC 3, bit 4, bit 3, CRC 2, CRC 1, bit 1, bit 2.

The service server 110 may set a frequency post of each of the bits of the sound wave data based on at least one of starting frequency information and minimum frequency interval information. Specifically, the service server 110 may set the frequency post of each of the bits of the sound wave data based on at least one of the starting frequency information and the minimum frequency interval information in the sound wave protocol matching the service type information. In this example, the sound wave data may be data encoded using the security key.

As an example, when the service type information is “payment”, the service server 110 may set a frequency post (or a starting frequency) of 18 kilohertz (kHz) for a first bit of the sound wave data. For a second bit, the service server 110 may set a frequency post of 18.05 kHz (=18 kHz+50 Hz). Likewise, the service server 110 may set frequency posts for other bits of the sound wave data. In this instance, a frequency interval between the frequency posts may be uniform, for example, 50 Hz.

As another example, when the service type information is “attendance”, the service server 110 may set a frequency post (or a starting frequency) of 18.5 kHz for a first bit of the sound wave data. For a second bit, the service server 110 may set a frequency post of 18.6 kHz (=18.5 kHz+100 Hz). Likewise, the service server 110 may set frequency posts for other bits of the sound wave data. In this instance, a frequency interval between the frequency posts may be uniform, for example, 100 Hz.

As another example, when the service type information is “marketing”, the service server 110 may set a frequency post (or a starting frequency) of 19 kHz for a first bit of the sound wave data. For a second bit, the service server 110 may set a frequency post of 19.1 kHz (=19 kHz+100 Hz). Likewise, the service server 110 may set frequency posts for other bits of the sound wave data. In this instance, a frequency interval between the frequency posts may be uniform, for example, 100 Hz.

As another example, when the service type information is “entry”, the service server 110 may set a frequency post (or a starting frequency) of 19.5 kHz for a first bit of the sound wave data. For a second bit, the service server 110 may set a frequency post of 19.55 kHz (=19.5 kHz+50 Hz). Likewise, the service server 110 may set frequency posts for other bits of the sound wave data. In this instance, a frequency interval between the frequency posts may be uniform, for example, 50 Hz.

Depending on an implementation, the service server 110 may set the frequency post of each of the bits of the sound wave data using different frequency intervals. For example, the service server 110 may set the frequency post (or the starting frequency) of 18 kHz for the first bit of the sound wave data, set the frequency post of 18.05 kHz (=18 kHz+50 Hz) or the second bit, set a frequency post of 18.13 kHz (=18 kHz+50 Hz+53 Hz) for a third bit of the sound wave data, and set a frequency post of 18.65 kHz (=18 kHz+50 Hz+53 Hz+52 Hz) for a fourth bit of the sound wave data. As such, intervals between the frequency posts may be different from one another, which may enhance the security.

Referring back to FIG. 2, in operation 218, the service server 110 may transmit the sound wave data to the terminal 120. The service server 110 may transmit information on the set frequency post to the terminal 120. Depending on an example, the service server 110 may transmit encoded sound wave data to the terminal 120.

In operation 219, the terminal 120 may generate a sound wave based on the sound wave data and output the sound wave. The terminal 120 may generate the sound wave further based on information on the frequency post received from the service server 110 and output the sound wave. For example, the terminal 120 may generate a sound wave tone in a frequency post of a bit having a bit value of 1 among the bits of the sound wave data, generate a multi-tone sound wave through an aggregation of the generated sound wave tone, and output the multi-tone sound wave. FIG. 4B illustrates an example of the multi-tone sound wave.

In operation 220, the terminal 130 may recognize the sound wave output by the terminal 120. In operation 221, the terminal 130 may transmit a sound wave recognition result to the service server 110. For example, when the multi-tone sound wave is received, the terminal 130 may identify a frequency of each sound wave tone and allocate “1” to the identified frequency. Through this, the terminal 130 may determine bits corresponding to the multi-tone sound wave. Also, the terminal 130 may change the arrangement of the corresponding bits received in operation 212, extract a body and a CRC based on the bits in the changed arrangement, and transmit a sound wave recognition result including the bits in the changed arrangement to the service server 110 when CRC checksum is correct. In other words, the terminal 130 may receive and analyze the sound wave output by the terminal 120 and transmit a sound wave analysis result to the service server 110. When the CRC checksum is not correct, the terminal 130 may continually receive and analyze the sound wave.

The terminal 130 may request the payload data A from the service server 110 while transmitting the sound wave recognition result to the service server 110.

In operation 222, the service server 110 may verify a validity of the sound wave recognition result of the terminal 130. For example, the service server 110 may verify a validity of the sound wave recognition result based on a generation point in time of the symbol A and a reception point in time of the sound wave recognition result. Specifically, the service server 110 may verify whether an elapsed time from the generation point in time of the symbol A to the reception point in time of the sound wave recognition result is within a predetermined time, for example, five minutes, thereby determining whether the sound wave recognition result is valid. When the elapsed time exceeds the predetermined time, the service server may determine that the sound wave recognition result of the terminal 130 is not valid and refuse a request of the terminal 130 for the payload data A.

When the sound wave recognition result of the terminal 130 is valid, the service server 110 may verify whether the sound wave recognition result matches the symbol A. When the sound wave recognition result matches the symbol A, the service server 110 may transmit the payload data A mapped with the symbol A to the terminal 130 in operation 223. In other words, when the sound wave recognition result of the terminal 130 is valid, the service server 110 may search for a symbol matching the sound wave recognition result. When the symbol A is found, the service server 110 may transmit the payload data A mapped with the symbol A to the terminal 130.

When the payload data A is received from the service server 110, the terminal 130 may transmit response data indicating that the payload data A is received, to the service server 110 in operation 224.

When the sound wave is output in operation 219, the terminal 120 may poll or make query about whether the terminal 130 receives the payload data A to the service server 110 at preset time intervals. When the response data is received from the terminal 130, the service server 110 may transmit response data indicating that the terminal 130 has received the payload data A to the terminal 120.

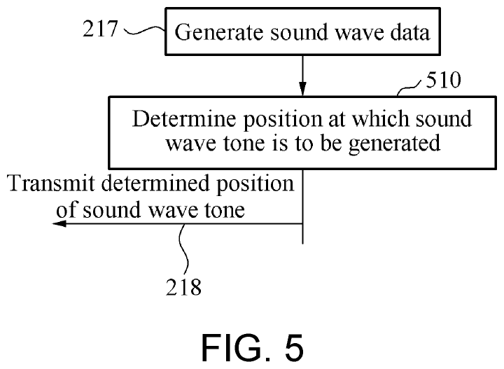

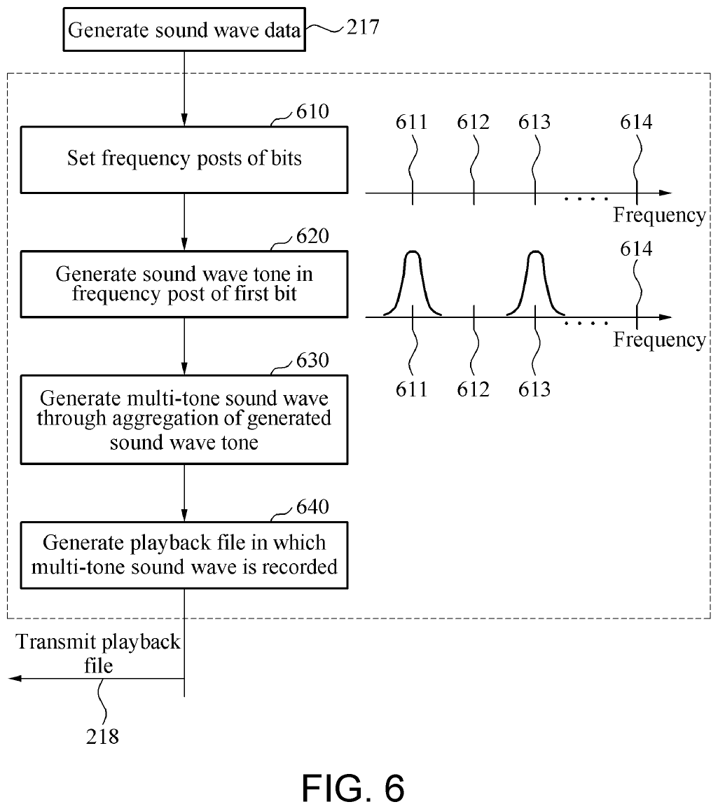

FIGS. 5 and 6 are diagrams illustrating another example of an operation of a sound wave communication platform according to an example embodiment.

Referring to FIG. 5, the service server 110 may generate sound wave data, when a frequency post is set, determine a position at which a sound wave tone is to be generated, and transmit the determined position of the sound wave tone to the terminal 120. In the example embodiment, the service server 110 may not transmit the sound wave data and information on the set the frequency post to the terminal 120. For example, the service server 110 may set frequency posts of bits of the sound wave data based on frequency interval information “100 Hz”, starting frequency information “18.5 kHz”, and sound wave data “10 . . . 1”, and identify a frequency post of a bit having a bit value “1” among the set frequency post “18.5 kHz, 18.6 kHz, . . . , 21.5 kHz.” The service server 110 may determine the identified frequency post to be a generation position of the sound wave tone and transmit the determined generation position of the sound wave tone to the terminal 120. The terminal 120 may generate the sound wave tone at the determined position to generate a multi-tone sound wave and output the multi-tone sound wave.

An example of the service server 110 generating a playback file and transmitting the playback file to the terminal 120 will be described with reference to FIG. 6. The playback file may also be referred to as a sound wave file.

Referring to FIG. 6, in operation 610, the service server 110 may determine frequency posts 611 through 614 of bits of sound wave data based on frequency interval information and starting frequency information corresponding to service type information.

In operation 620, the service server 110 may generate a sound wave tone in a frequency post of a first bit among the bits of the sound wave data.

In operation 630, the service server 110 may generate a multi-tone sound wave through an aggregation of the generated sound wave tone.

In operation 640, the service server 110 may generate a playback file in which the multi-tone sound wave is recorded. The playback file may be, for example, a file with a way extension. A type of the playback file is not limited thereto.

The service server 110 may transmit the playback file to the terminal 120. The terminal 120 may play the playback file, thereby outputting a multi-tone sound wave having the same waveform as that of operation 620.

In one example, the service server 110 may transmit location information of the playback file to the terminal 120 instead of transmitting the playback file to the terminal 120. The location information of the playback file may include, for example, a URL. When the location information of the playback file is received, the terminal 120 may access the location information to play the playback file.

In another example, the service server 110 may transmit information required for the terminal 120 to generate the playback file to the terminal 120. Such information may include any one or combinations of the sound wave data, the frequency interval information, the starting frequency information, a sampling rate, and volume information. The terminal 120 may use the information to generate the playback file and play the generated playback file.

<Case of a Large Amount of Sound Wave Data>

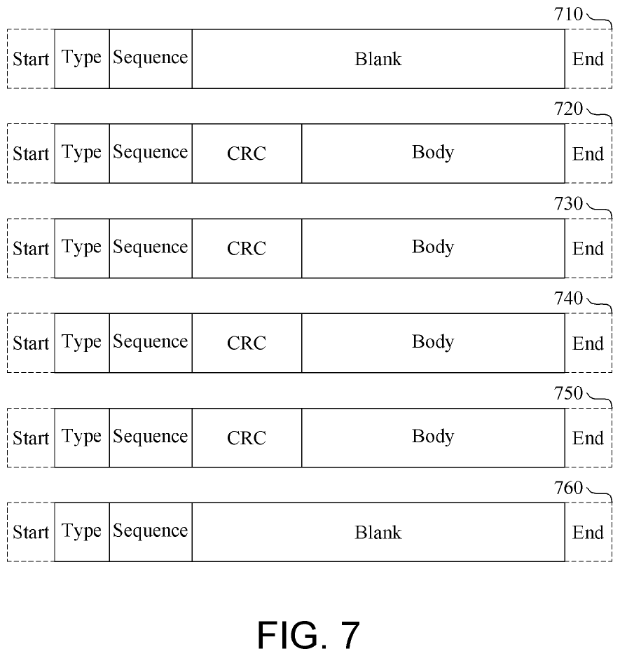

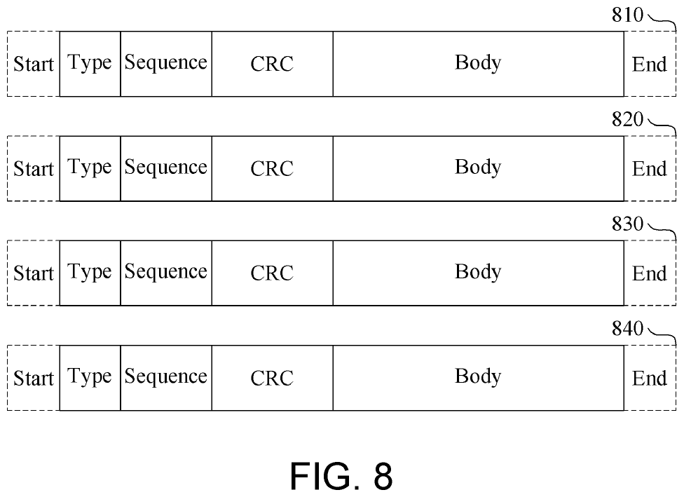

FIGS. 7 and 8 are diagrams illustrating a case in which an amount of sound wave data of a sound wave communication platform is relatively large according to an example embodiment.

The service server 110 may generate a symbol having a size greater than the symbol size represented in Table 1. In this case, sound wave data may exceed a predetermined size, for example, 64 bits. When a total size of the sound wave data excesses the predetermined size, it may be difficult to transmit the sound wave data to the terminal 130 using a single multi-tone sound wave. In this case, the service server 110 may generate a sound wave data set and transmit the sound wave data set to the terminal 120. Hereinafter, how the service server 110 generate the sound wave data set will be described.

When the service server 110 generates, for example, a 96-bit symbol, the service server 110 may divide the 96-bit symbol into four 24-bit symbols in consideration of a size of a body field, 24 bits. That is, four divided symbols may be generated.

The service server 110 may set a value for each field of Table 3, thereby generating sound wave data 710 through 760 of FIG. 7, that is, a sound wave data set.

TABLE 3

| Field | Description |
|---|---|
| Type | Field size = 2 bits |
| | Indicating type of sound wave data |
| | 00: Start sound wave data |
| | 01: Sound data including divided symbol |
| | 10: Last sound wave data |
| Sequence | Field size = 4 bits |
| | If type is 00 or 10, indicating the number of items of |
| | sound wave data of which type is set to 01. |
| | If type is 01, indicating transmission order of sound |
| | wave data having type set to 01. If transmitted |
| | first, 0000 is set. |
| CRC | Field size = 8 bits |
| | Error correction code of divided symbol is set. |
| Body | Field size = 24 bits |
| | Divided symbol is set. |
| Blank | Field size = 32 bits |
| | If type is 00 or 10, 32 zeros are set. |

Table 4 shows an example of the sound wave data 710 through 760.

TABLE 4
Sound wave data 710: type = 00, sequence = 0100, blank = 32 zeros
Sound wave data 720: type = 01, sequence = 0000, CRC = 8 bits, body =
divided symbol 1
Sound wave data 730: type = 01, sequence = 0001, CRC = 8 bits, body =
divided symbol 2
Sound wave data 740: type = 01, sequence = 0010, CRC = 8 bits, body =
divided symbol 3
Sound wave data 750: type = 01, sequence = 0011, CRC = 8 bits, body =
divided symbol 4
Sound wave data 760: type = 10, sequence = 0100, blank = 32 zeros

In terms of the sound wave data 720, since the sound wave data 720 is transmitted first to the terminal 120 among the sound wave data 720 through 750 having a type=01, 0000 may be set in a sequence field. In terms of the sound wave data 730, since the sound wave data 730 is transmitted second to the terminal 120 among the sound wave data 720 through 750 having the type=01, 0001 may be set in a sequence field. In terms of the sound wave data 740, since the sound wave data 740 is transmitted third to the terminal 120 among the sound wave data 720 through 750 having the type=01, 0010 may be set in a sequence field. In terms of the sound wave data 750, since the sound wave data 750 is transmitted fourth to the terminal 120 among the sound wave data 720 through 750 having the type=01, 0011 may be set in a sequence field.

Since four items of the sound wave data correspond to the type set to 01, 0100 may be set in the sequence field of each of the sound wave data 710 and the sound wave data 760.

Depending on an example, a start bit field and an end bit field may be further included in each item of the sound wave data 710 through 760. In this example, each of the start bit field and the end bit field may be biased to 1.

In another example, the service server 110 may set a value for each field of Table 5, thereby generating sound wave data 810 through 840 of FIG. 8, that is, a sound wave data set.

TABLE 5

| Field | Description |
|---|---|
| Type | Field size = 2 bits |
| | Indicating type of sound wave data |
| | 00: Start sound wave data |
| | 01: Intermediate sound wave data |
| | 10: Last sound wave data |
| Sequence | Field size = 4 bits |
| | Indicating transmission order of sound wave data. |
| | If transmitted first, 0000 is set. |
| CRC | Field size = 8 bits |
| | Error correction code of divided symbol is set. |
| Body | Field size = 24 bits |
| | Divided symbol is set. |

Table 6 shows an example of the sound wave data 810 through 840.

TABLE 6
Sound wave data 810: type = 00, sequence = 0000, CRC = 8 bits, body =
divided symbol 1
Sound wave data 820: type = 01, sequence = 0001, CRC = 8 bits, body =
divided symbol 2
Sound wave data 830: type = 01, sequence = 0010, CRC = 8 bits, body =
divided symbol 3
Sound wave data 840: type = 10, sequence = 0011, CRC = 8 bits, body =
divided symbol 4

In terms of the sound wave data 810, since the sound wave data 810 is start data of the sound wave data set, 00 is set in a type field. Also, since the sound wave data 810 is transmitted first, 0000 is set in a sequence field.

In terms of the sound wave data 840, since the sound wave data 840 is last data of the sound wave data set, 10 is set in a type field. Also, since the sound wave data 840 is transmitted fourth, 0011 is set in a sequence field.

Depending on an example, a start bit field and an end bit field may be further included in each item of the sound wave data 810 through 840. In this example, each of the start bit field and the end bit field may be biased to 1.

The service server 110 may transmit the sound wave data of FIG. 7 or 8 to the terminal 120. The terminal 120 may generate a multi-tone sound wave for each item of sound wave data included in the sound wave data set and output the generated multi-tone sound wave. For example, the terminal 120 may generate a multi-tone sound wave corresponding to each item of the sound wave data 710 through 760. In other words, the terminal 120 may generate a multi-tone sound wave set corresponding to the sound wave data 710 through 760. The terminal 120 may output the multi-tone sound wave corresponding to the sound wave data 710, and then sequentially output the multi-tone sound waves corresponding to the sound wave data 720 through 760. In this example, a time interval between a multi-tone sound wave and the following multi-tone sound wave may be 200 milliseconds (ms).

In one example, when the service server 110 generates a sound wave data set, the service server may operate as described in the example of FIG. 5. In another example, the service server 110 generates a sound wave data set, the service server may generate a playback file corresponding to the sound wave data set and transmit the playback file to the terminal 120 as described in the example of FIG. 6. Alternatively, the service server 110 may transmit location information of the playback file to the terminal 120 or transmit information required for the terminal 120 to generate the playback file to the terminal 120.

Since the description of FIGS. 1 through 6 is also applicable here, repeated description of FIG. 7 will be omitted.

<Sound Wave Communication Platform—One-Way Sound Wave-Based Two-Way Data Transmission>

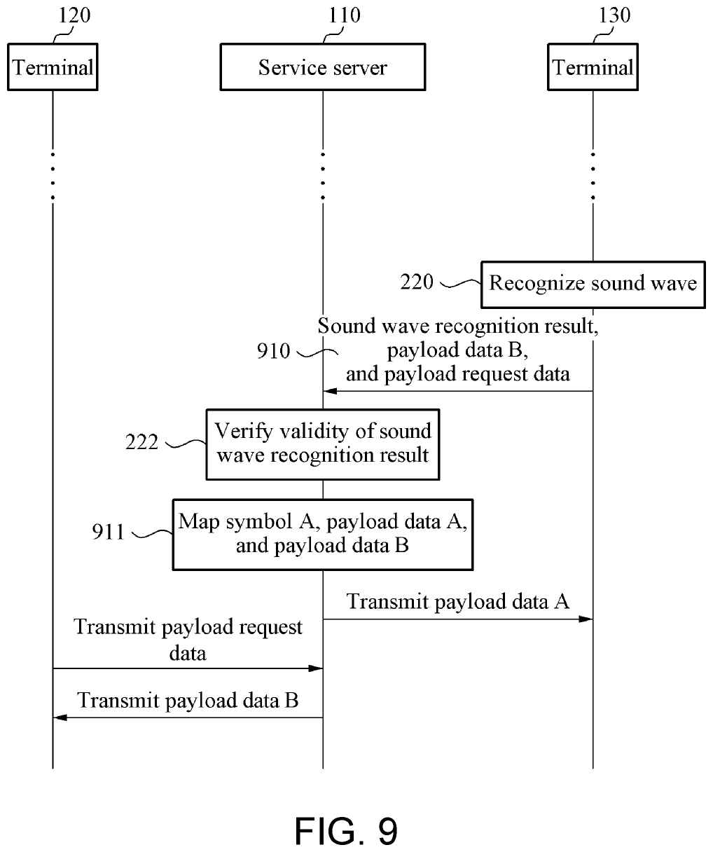

FIG. 9 is a diagram illustrating another example of a sound wave communication platform according to an example embodiment.

Referring to FIG. 9, in operation 910, the terminal 130 may transmit a sound wave recognition result, payload data B, and payload request data to the service server 110. In other words, the terminal 130 may request payload data A from the service server 110 while transmitting the sound wave recognition result and, simultaneously, transmit the payload data B of the terminal 130 to the service server 110.

In operation 222, the service server 110 may verify a validity of the sound wave recognition result.

When the sound wave recognition result is valid, the service server 110 may map the symbol A, the payload data A, and the payload data B in operation 911. In other words, when the sound wave recognition result is valid, the service server 110 may generate additional mapping information by mapping the payload data B to the mapping information generated in operation 216. The additional mapping information may be associated with both the terminal 120 and the terminal 130.

The service server 110 may verify whether the sound wave recognition result matches the symbol A. When the sound wave recognition result matches the symbol A, the service server 110 may transmit the payload data A mapped with the symbol A to the terminal 130.

The service server 110 may receive the payload request data from the terminal 120. In other words, the terminal 120 may request the payload data B from the service server 110. In response to such request, the service server 110 may transmit the payload data B to the terminal 120 based on the additional mapping information generated in operation 911.

Since the description of FIGS. 1 through 8 is also applicable here, repeated description of FIG. 9 will be omitted.

<Sound Wave Communication Platform—Two-Way Sound Wave-Based Two-Way Data Transmission>

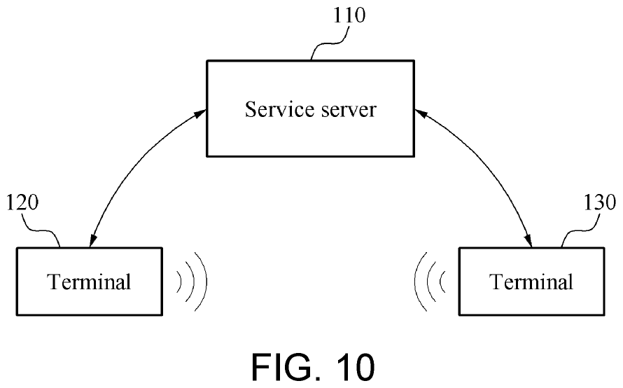

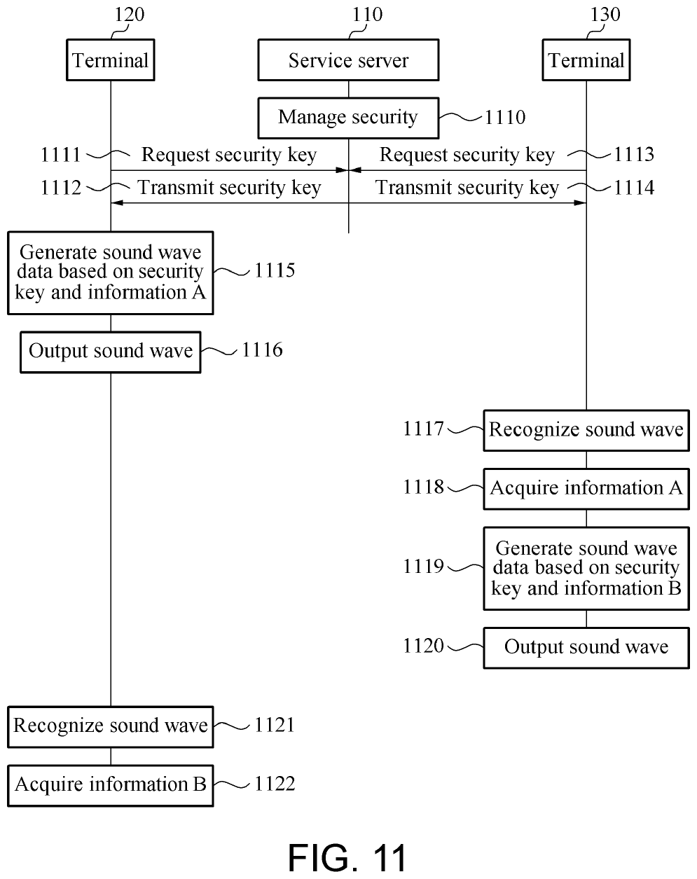

FIGS. 10 and 11 are diagrams illustrating another example of a sound wave communication platform according to an example embodiment.

Referring to FIG. 10, both of the terminals 120 and 130 may output sound waves. In other words, in addition to sound wave communication from the terminal 120 to the terminal 130, sound wave communication from the terminal 130 to the terminal 120 may also be available. An operating method of a sound wave communication platform of FIG. 10 will be described with reference to FIG. 11.

Referring to FIG. 11, in operation 1110, the service server 110 may manage a security key. Since the description is given of the security key as above, repeated description will be omitted.

In operation 1111, the terminal 120 may request the security key from the service server 110. In operation 1112, the service server 110 may transmit the security key to the terminal 120.

In operation 1113, the terminal 130 may request the security key from the service server 110. In operation 1114, the service server 110 may transmit the security key to the terminal 130.

In operation 1115, the terminal 120 may generate sound wave data based on the security key and information A owned by itself. The information A may correspond to, for example, a text, a static image, a dynamic image, or a URL. The aforementioned scheme for generating the sound wave data in the service server 110 may be applicable to operation 1115 in which the sound wave data is generated and thus, repeated description will be omitted. Depending on an implementation, the terminal 120 may generate a playback file and play the playback file in operation 1115.

In operation 1116, the terminal 120 may generate a sound wave based on the sound wave data and output the sound wave. The aforementioned scheme for outputting the sound wave may be applicable to operation 1116 in which the sound wave is output and thus, repeated description will be omitted.

The terminal 130 may recognize the sound wave output by the terminal 120 in operation 1117 and acquire the information A in operation 1118. For example, the terminal 130 may determine bits corresponding to the sound wave, shuffle the determined bits using the security key, and extract the information A from the shuffled bits.

In operation 1119, the terminal 130 may generate sound wave data based on the security key and information B owned by itself. The information B may correspond to, for example, a text, a static image, a dynamic image, or a URL. The aforementioned scheme for generating the sound wave data in the service server 110 may be applicable to operation 1119 in which the sound wave data is generated and thus, repeated description will be omitted. Depending on an implementation, the terminal 130 may generate a playback file and play the playback file in operation 1119.

In operation 1120, the terminal 130 may generate a sound wave based on the sound wave data and output the sound wave.

The terminal 120 may recognize the sound wave output by the terminal 130 in operation 1121 and acquire the information B in operation 1122. For example, the terminal 120 may determine bits corresponding to the sound wave, shuffle the determined bits using the security key, and extract the information B from the shuffled bits.

Based on the sound wave communication platform described with reference to FIGS. 10 and 11, direct communication may be performed between the terminal 120 and the terminal 130.

Since the description of FIGS. 1 through 9 is also applicable here, repeated description of FIGS. 10 and 11 will be omitted.

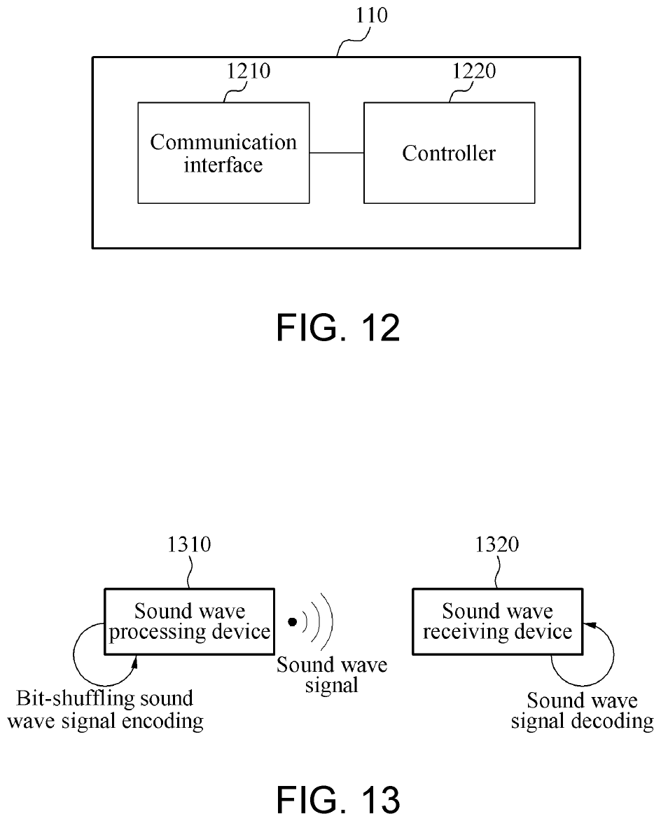

FIG. 12 is a block diagram illustrating a service server of a sound wave communication platform according to an example embodiment.

Referring to FIG. 12, the service server 110 may include a communication interface 1210 and a controller 1220.

The communication interface 1210 may perform wired communication or wireless communication.

The controller 1220 may be coupled to the communication interface 1210. To implement a specific service on the sound wave communication platform 100, the communication interface 1210 and the controller 1220 may operate as follows.

The controller 1220 may transmit a security key to a terminal through the communication interface 1210 and receive payload data and symbol request data including service type information from another terminal.

The controller 1220 may generate a symbol corresponding to the other terminal based on a size determined based on the service type information.

The controller 1220 may generate mapping information in which the payload data and the generated symbol are mapped with respect to the other terminal.

The controller 1220 may generate sound wave data for outputting a sound wave of the other terminal based on the generated symbol. The sound wave data may include, for example, the generated symbol or an error correction code. Also, the sound wave data may be encoded based on the security key.

The controller 1220 may transmit the generated sound wave data to the other terminal through the communication interface 1210.

The controller 1220 may receive a sound wave recognition result and payload request data generated based on the sound wave and the security key from the terminal through the communication interface 1210. Here, the sound wave may be a sound wave output by the other terminal based on data received from the service server 110.

The controller 1220 may verify whether the sound wave recognition result matches the generated symbol. When the sound wave recognition result matches the generated symbol, the controller 1220 may transmit the payload data to the terminal through the communication interface 1210 based on the mapping information.

Since the description of FIGS. 1 through 11 is also applicable here, repeated description of FIG. 12 will be omitted.

<Application Example of Sound Wave Communication Platform>

As described above, a sound wave communication platform may be applied to various services. For example, a sound wave communication platform applied to an attendance check service will be described.

The terminal 120 may be a terminal installed in a lecture place. The terminal 130 may be a terminal of a user who listens to a lecture in the lecture place. An attendance check application may be installed in the terminal 130.

The terminal 120 may transmit attendance authentication information of the lecture place to the service server 110 as payload data, receive sound wave data from the service server 110, and output a sound wave. The attendance authentication information may include at least one of location information (e.g., a lecture room B of a school A) of the lecture place, lecturer information (e.g., a professor's name), and lecture information (e.g., a lecture title and a lecture time). The terminal 130 may transmit a sound wave recognition result obtained by recognizing the sound wave and user information of the terminal 130 to the service server 110.

When the sound wave recognition result matches a symbol corresponding to the terminal 120, the service server 110 may determine that the user of the terminal 130 attends the lecture place and transmit the attendance authentication information or attendance verification information to the terminal 130. The terminal 130 may check that the user attends the lecture based on the attendance authentication information or the attendance verification information.

<Communication Using Sound Wave Signal>

FIG. 13 is a diagram illustrating a communication method using a sound wave signal according to an example embodiment.

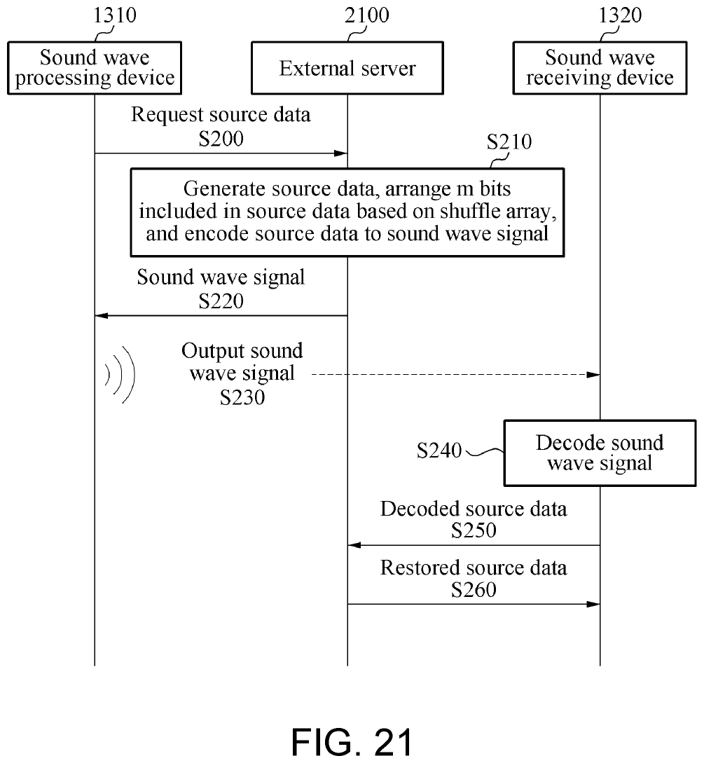

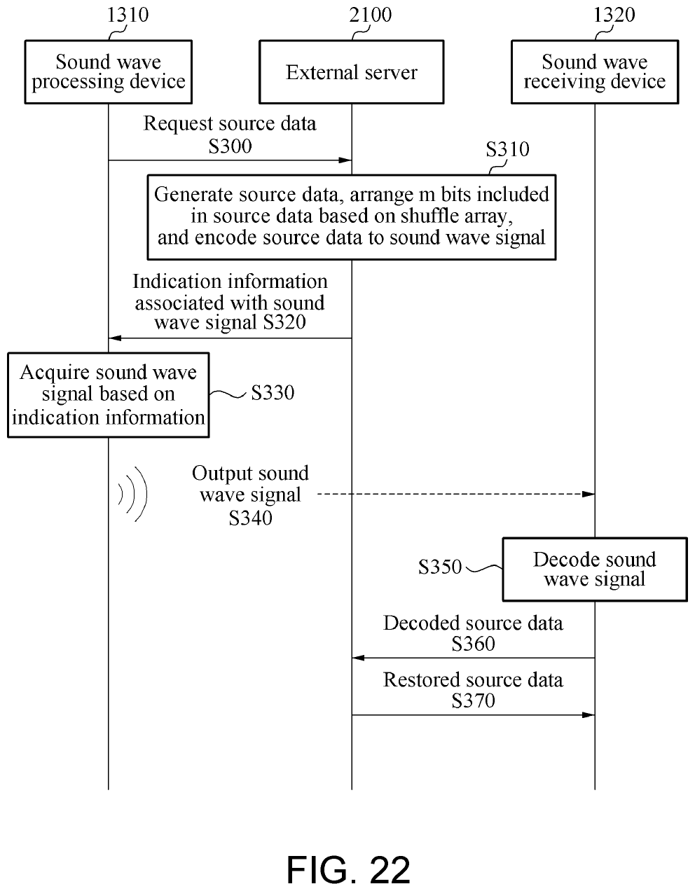

Referring to FIG. 13, a communication method using a sound wave signal may be performed by a sound wave processing device 1310 and a sound wave receiving device 1320. Depending on an example, sound wave communication may be performed additionally using an external server. The sound wave communication performed additionally using the external server will be described with reference to FIGS. 21 and 22. The external server may correspond to the service server 110. The sound wave processing device 1310 may generate source data to be transmitted to the sound wave receiving device 1320 and arrange m bits included in the source data based on a shuffle array used as a security code, thereby processing the source data. The source data or the processed source data may refer to data before being encoded to a sound wave signal.

The source data may vary based on a type of service that uses the sound wave communication.

As an example, when a service type is an Internet of things (IoT) service, source data may be identification information required for the IoT service such as Wireless Fidelity (WiFi) information, an IoT device, and the like.

As another example, when a service type is an attendance check, source data may be information on a lecture room and a professor.

As another example, when a service type is marketing, source data may be advertisement information.

As another example, when a service type is an entry management, source data may be visitor information (e.g., a resident ID).

The sound wave processing device 1310 may process the source data by arranging m bits included in the source data based on a shuffle array used as a security code, which may also be referred to as “bit shuffling.” The shuffle array may be stored in a sound wave communication application of the sound wave processing device 1310 or generated by the application using at least one parameter (e.g., date and time).

The sound wave processing device 1310 may encode the processed source data to a sound wave signal.

The sound wave processing device 1310 may output the encoded sound wave signal. The sound wave receiving device 1320 may decode the sound wave signal received from the sound wave processing device located at a short distance, to the processed source data. The sound wave receiving device 1320 may acquire m bit values by decoding the sound wave signal to the processed source data. The sound wave receiving device 1320 may have a shuffle array corresponding to the shuffle array owned by the sound wave processing device 1310 and post array information corresponding to m frequency posts. Depending on an example, the sound wave receiving device 1320 may receive the shuffle array and the post array information together with the encoded sound wave signal from the sound wave processing device 1310. The sound wave receiving device 1320 may rearrange the m bit values included in the processed source data based on the shuffle array and the post array information, thereby restoring the processed source data to be raw source data.

FIG. 13 illustrates one-way sound wave communication through which the sound wave processing device 1310 transmits a sound wave signal to the sound wave receiving device 1320. Such one-way sound wave communication may be different from two-way sound wave communication in which different performers of sound wave communication output a sound wave signal to each other.

Specifically, to perform the two-way sound wave communication, both the sound wave processing device 1310 and the sound wave receiving device 1320 may be provided with a microphone. In the one-way sound wave communication, the sound wave processing device 1310 may not receive a sound wave but output the sound wave and thus, may not be equipped with a microphone. Since the sound wave communication may be performed using a currently used sound wave processing device, for example, a POS device or a sign pad, not including a microphone unit, there is no need to replace the sound wave processing device 1310 with a device including a microphone to perform the sound wave communication.

<Method of Generating Sound Wave Signal for Sound Wave Communication>

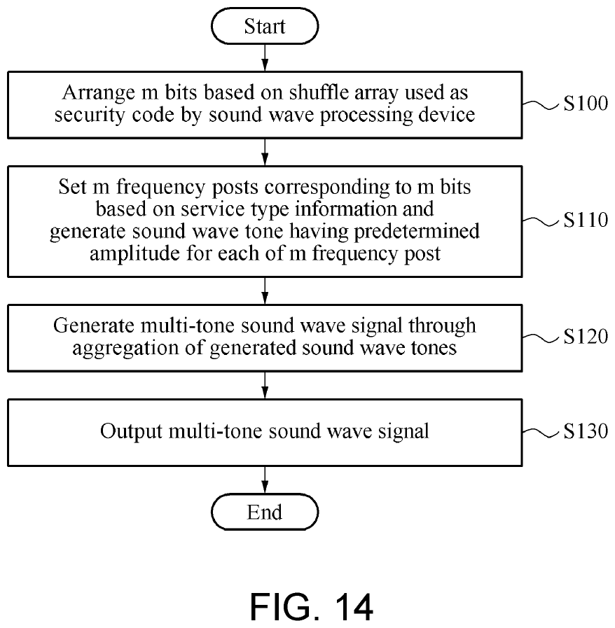

FIG. 14 is a flowchart illustrating a communication method using a sound wave signal according to an example embodiment.

Referring to FIG. 14, in operation S100, the sound wave processing device 1310 may process source data by arranging m bits included in the source data based on a shuffle array used as a security code.

Referring to FIG. 14 continuously, in operation S110, the sound wave processing device 1310 may set m frequency posts corresponding to the m bits included in the source data based on service type information and generate a sound wave tone having a predetermined amplitude for each of m frequency posts.

In the sound wave communication, different frequency bands may be used based on the service type information. For example, a frequency band of 18 kHz to 20 kHz may be used for a coupon service, a frequency band of 17.5 kHz to 20 kHz may be used for an attendance check, a frequency band of 17 kHz to 20 kHz may be used for marketing, and a frequency band of 17.4 kHz to 19.8 kHz may be used for entry management.

<Position of Initial Frequency Post>

A position of an initial frequency post among the m frequency posts used in the sound wave communication may be differently set based on the service type information.

As an example, when service type information is a coupon, a position of the initial frequency post may be 18 kHz.

As another example, when service type information is an attendance check, a position of the initial frequency post may be 17.5 kHz.

As another example, when service type information is marketing, a position of the initial frequency post may be 17 kHz.

As another example, when service type information is an entry management, a position of the initial frequency post may be 17.4 kHz.

As such, a position of the initial frequency post may be differently set based on the service type information, thereby enhancing security of the sound wave communication.

<Minimum Frequency Interval>

A minimum frequency interval between the m frequency posts used in the sound wave communication may be differently set based on the service type information.

As an example, when service type information is a coupon, a lot of bits may need to be transmitted within a limited band. In this example, a relatively large number of bits, for example, m may be used for the sound wave communication when compared to other types of services and thus, a minimum frequency interval between the m frequency posts may be 50 Hz.

As another example, when service type information is an attendance check, less-bit transmission is required in comparison to the coupon. In this example, a relatively small number of bits, for example, m may be used for the sound wave communication when compared to other types of services. Also, in a case of the attendance check, long-distance recognition is relatively important and a mutual interference between post frequencies may need to be minimized. Thus, a minimum frequency interval between the m frequency posts may be, for example, 100 Hz which is greater than those of other types of services.

As another example, when service type information is marketing, a minimum frequency interval between the m frequency posts may be 100 Hz.

As another example, when service type information is an entry management, a minimum frequency interval between the m frequency posts may be 40 Hz.

By setting the minimum frequency interval, an interference between the frequency posts may be prevented. Also, by differently setting the minimum frequency interval based on the service type information, the security of the sound wave communication may be enhanced.

<Uniform Interval Between Frequency Posts>

A frequency interval between m frequency posts used in the sound wave communication may be set uniformly.

As an example, when service type information is a coupon, a frequency interval between the m frequency posts may be uniformly set to 50 Hz.

As another example, when service type information is an attendance check, a frequency interval between the m frequency posts may be uniformly set to 100 Hz.

As another example, when service type information is marketing, a frequency interval between the m frequency posts may be uniformly set to 100 Hz.

As another example, when service type information is an entry management, a frequency interval between the m frequency posts may be uniformly set to 40 Hz.

<Non-Uniform Interval Between Frequency Posts>

A frequency interval between m frequency posts used in the sound wave communication may be set non-uniformly. For example, a frequency interval between a first, that is, initial frequency post and a second frequency post may be set to 50 Hz and a frequency interval between the second frequency post and a third frequency post may be set to 60 Hz. Even when the frequency interval is non-uniform, a minimum frequency interval between the frequency posts may be maintained to prevent the interference between the frequency posts.

In addition, a sound wave protocol may also be differently set based on a type of service in which the sound wave communication is used. Accordingly, a configuration of m, the number of bits included in data (an error correction code, a payload, a start bit, an end bit, etc.) may be differently set based on a type of service in which the sound wave communication is used.

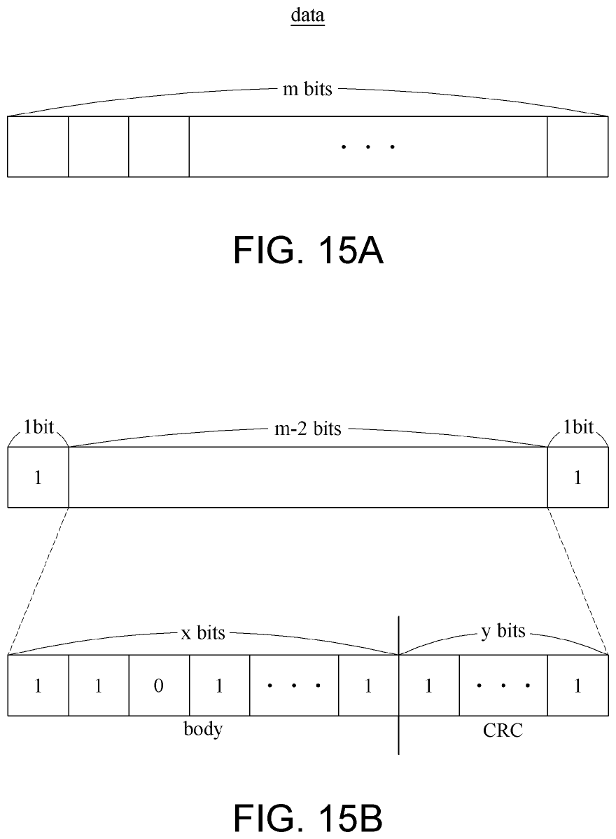

FIGS. 15A and 15B are block diagrams of a sound wave protocol used in sound wave communication according to an example embodiment.

Referring to FIG. 15A, source data used in communication performed using a sound wave may include at least m bits. Referring to FIG. 15B, a foremost bit (hereinafter, referred to as “start bit”) and a rearmost bit (hereinafter, referred to as “end bit”) of the m bits may indicate a start and an end of data, respectively.

The start bit and the end bit may also be referred to as a beacon start and a beacon end, respectively. The start bit and the end bit may always be set to “1.” When data includes the start bit and the end bit, a boundary from another data may be clarified, so that encoded data is decoded with increased accuracy. The start bit and the end bit may be used or omitted depending on an example.

The data may include a body and an error correction code, for example, cyclic redundancy check (CRC). The body may be a portion of data corresponding to a fundamental purpose of data communication and may indicate data excluding a header or metadata. The error correction code may include eight bits.

Referring to FIG. 15B, data may include a body including x bits and an error correction code including y bits, for example, m−2=x+y. An initial bit through a fourth bit of the body may be “1”, “1”, “0”, and “1”, respectively. An initial bit and a last bit of the error correction code may be “1.”

The source data may include a time code associated with a time in which a sound wave signal is generated or bit shuffling is performed. The time code may be used to determine whether the sound wave signal is valid. For example, when decoding the received sound wave signal, the sound wave receiving device 1320 may use the time code. When a time in which the sound wave signal is received from the sound wave processing device 1310 exceeds a threshold time from a time at which the sound wave signal is generated, the sound wave receiving device 1320 may determine that the sound wave signal is invalid based on time information extracted from the time code.

In one example, as a result of decoding the sound wave signal, when the sound wave receiving device 1320 determines that the sound wave signal is invalid, the sound wave receiving device 1320 may not request information corresponding to the sound wave signal from the external server. In another example, when it is determined that the sound wave signal is invalid, the external server may not transmit corresponding information to the sound wave receiving device 1320 even if an information request is received from the sound wave receiving device 1320.

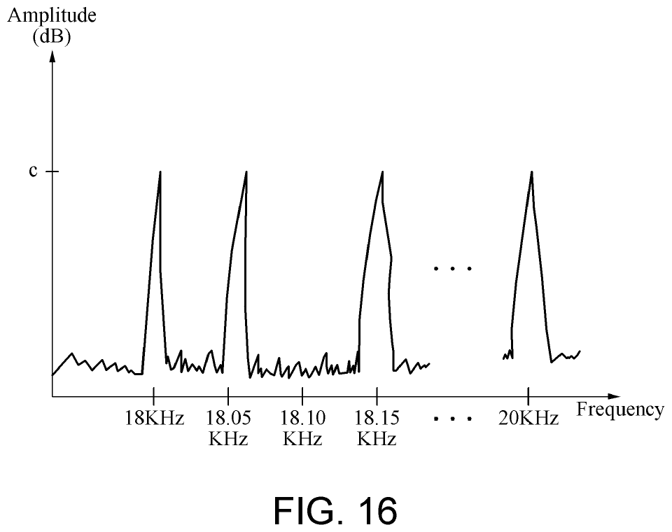

FIG. 16 illustrates a frequency used in sound wave communication and a sound wave tone of the frequency according to an example embodiment.

Referring to FIG. 16 and FIG. 15B, a frequency band used for sound wave communication may be 18 kHz through 20 kHz. A number of bits included in data, that is, a number of frequency posts may be 20. A plurality of frequency posts may be provided at preset intervals, for example, 50 Hz. An amplitude of a sound wave tone generated in a frequency post may be a predetermined value, for example, c. The amplitude of sound wave tone generated in the frequency post may be determined based on service type information of a service in which the sound wave communication is used. Different frequency bands, number of bits, and frequency intervals may be used for a coupon, an attendance management, marketing, and an entry management.

Referring to FIG. 16, the frequency band used for the sound wave communication may be 18 kHz through 20 kHz. When 20 frequency posts are set in the frequency band, the set frequency posts may have uniform frequency intervals of 50 Hz. FIG. 16 illustrates frequency posts set in frequencies of 18 kHz, 18.05 kHz, 18.10 kHz, and 18.15 kHz through 20 kHz.

The sound wave tone may be generated in a frequency post corresponding to a bit “1” of data. Referring to FIG. 15B and FIG. 16, when an initial bit through a fourth bit of a body of data are respectively “1”, “1”, “0”, and “1”, and a last bit of an error correction code is “1”, the sound wave processing device 1310 may generate a sound wave tone having an amplitude of c dB for 18 kHz, 18.05 kHz, 18.15 kHz, and 20 kHz of which corresponding bits are “1”. In FIG. 15B, since a third bit of a payload is “0”, the sound wave processing device 1310 may not generate a sound wave tone in a frequency post corresponding to the third bit, that is, 18.10 kHz.

Although not shown, to enhance security, frequency intervals between m frequency posts used for the sound wave communication may be set non-uniformly. For example, a frequency interval between a first, that is, initial frequency post and a second frequency post may be 50 Hz, a frequency interval between the second frequency post and a third frequency post may be 60 Hz, and a frequency interval between a (m−2)^{th} frequency post and a (m−1)^{th} the frequency post may be 55 Hz. Even when the frequency interval is non-uniform, a minimum frequency interval between the frequency posts may be maintained to prevent an interference between the frequency posts.

Referring back to FIG. 14, in operation S120, the sound wave processing device 1310 may generate a multi-tone sound wave signal through an aggregation of the generated sound wave tones.

In a currently used communication method using a sound wave signal, a plurality of sound wave tones generated in frequency posts may be output in sequence. When the plurality of sound wave tones are sequentially output, a time required to transmit the sound wave tones to the sound wave receiving device 1320 may increase proportionally to a number of frequency posts in which the sound wave tones are generated. In contrast, the sound wave processing device 1310 may output a multi-tone sound wave signal generated through the aggregation of the sound wave tones generated in the plurality of frequency posts. When the sound wave tones are output through the aggregation, sound wave signals may be transmitted to the sound wave receiving device 1320 at one time. Thus, a relatively large amount of data may be transmitted within the same time when compared to the method of outputting the sound wave tones in sequence. For example, when a predetermined amplitude of sound wave tone is generated in each of n frequency posts, the sound wave processing device 1310 may generate a multi-tone sound wave into which the n the sound wave tones are aggregated.

Referring back to FIG. 14, in operation S130, the sound wave processing device 1310 may output the multi-tone sound wave signal.

The sound wave processing device 1310 may output the generated multi-tone sound wave signal through a speaker included therein. An example of outputting a sound wave signal will be described in detail with reference to <Output of sound wave signal>below.

<Security of Sound Wave Signal>

In order to enhance security of sound wave communication, the sound wave processing device 1310 may process source data by arranging m bits included in the source data based on a shuffle array before the source data is transmitted to the sound wave processing device 1310.

Through such processing, the bits may be arranged in m!(m*(m−1)* . . . *2*1) ways. The sound wave receiving device 1320 may encode the sound wave signal received from the sound wave processing device 1310 to the processed source data and restore, using a shuffle array owned by sound wave receiving device 1320 or received from the sound wave processing device 1310 as a security code, the m bits to be in a state of before being arranged by the sound wave processing device 1310 using the shuffle array, that is, the source data having not been processed. By diversifying the shuffle array in m! ways, the security of the sound wave communication may be enhanced.

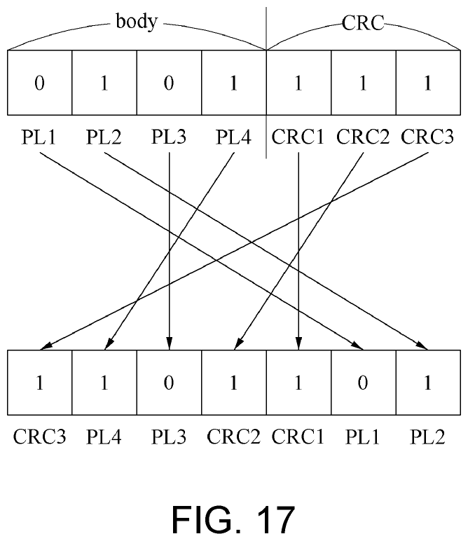

FIG. 17 illustrates a security algorithm of sound wave communication according to an example embodiment.

Referring to FIG. 17, a body may include four bits “0”, “1”, “0”, and “1” and an error correction code may include three bits“1”, “1”, and “1”. As shown in FIG. 17, an n^{th} bit included in the body may be represented as PLn and an n^{th} bit included in the error correction code may be represented as CRCn. For example, a first bit included in the body may be represented as PL1, a second bit included in the body may be represented as PL2, a third bit included in the body may be represented as PL3, and a fourth bit included in the body may be represented as PL4. Also, a first bit included in the error correction code may be represented as CRC1, a second bit included in the error correction code may be represented as CRC2, and a third bit included in the error correction code may be represented as CRC3.

The sound wave processing device 1310 may arrange the bits included in the payload and the error correction code based on a predetermined reference, for example, the shuffle array. Also, when arranging the bits included in the source data, the sound wave processing device 1310 may arrange the bits by distinguishing between the body and the error correction code or without distinguishing the body and the error correction code. As shown in FIG. 17, by shuffling the bits included in the body and the error correction code, PL1 may be changed from the first bit to a sixth bit, PL2 may be changed from the second bit to a seventh bit, PL3 may remain as the third bit without a change, PL4 may be changed from the fourth bit to a second bit, CRC1 may remain as a fifth bit, CRC2 may be changed from a sixth bit to a fourth bit, and CRC3 may be changed from a seventh bit to a first bit. An upper portion of FIG. 17 represents source data having not been processed and a lower portion of FIG. 17 represents processed source data.

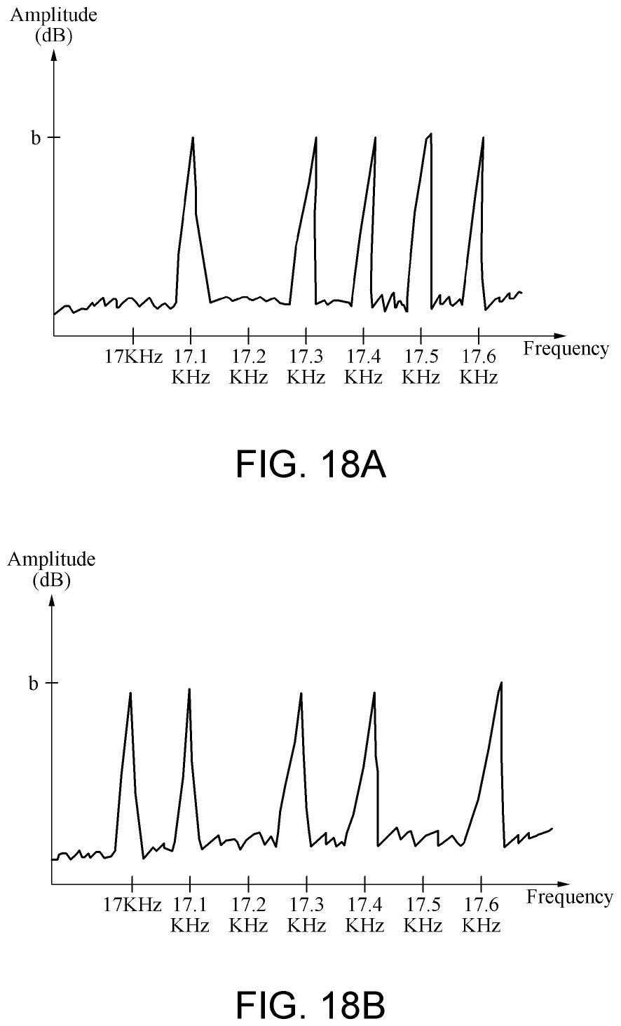

FIG. 18A illustrates positions of frequency posts corresponding to bits included in source data before the bits are arranged. Referring to FIGS. 17 and 18A, data may include seven bits. Also, a frequency band of the data may be 17 kHz through 20 kHz. Thus, the frequency posts may be set in 17.00 kHz, 17.10 kHz, 17.20 kHz, 17.30 kHz, 17.40 kHz, 17.50 kHz, and 17.60 kHz. Referring to FIG. 17, bits included in data before rearrangement (the payload and the error correction code) may be “0”, “1”, “0”, “1”, “1”, “1”, and “1.” The sound wave processing device 1310 may not generate a sound wave tone in a frequency post, for example, 17.00 kHz and 17.20 kHz, corresponding to a bit “0,” and generate a sound wave tone having an amplitude of b dB in a frequency post, for example, 17.10 kHz, 17.30 kHz, 17.40 kHz, 17.50 kHz, and 17.60 kHz corresponding to a bit “1.”

FIG. 18B illustrates positions of frequency posts corresponding to source data processed by arranging bits included in the source data based on a shuffle array. Referring to FIG. 17 and FIG. 18B, bits included in data may be rearranged from “0”, “1”, “0”, “1”, “1”, “1”, “1” to “1”, “1”, “0”, “1”, “1”, “0”, “1”. In this example, even though the positions of the frequency post have changed, intervals between the frequency posts are maintained as 100 Hz. Referring to FIG. 17, since bits rearranged in the data are “1”, “1”, “0”, “1”, “1”, “0”, “1”, the sound wave processing device 1310 may generate sound wave tones for the frequency post based on the rearranged bits. For example, the sound wave processing device 1310 may generates the sound wave tones in the frequency posts, that is, 17.00 kHz, 17.10 kHz, 17.30 kHz, 17.40 kHz, and 17.60 kHz corresponding to a bit “1” after the rearrangement, and may not generate the sound wave tone in the frequency posts, that is, 17.20 kHz and 17.50 kHz corresponding to a bit “0” after the rearrangement.

<Example of Generating Sound Wave Signal Based on Service Type Information>

The communication method using a sound wave signal may be applied to various types of services such as a coupon, an attendance check management, marketing, and an entry management in addition to data transmission. Also, a frequency band, a number of bits, and a frequency post interval used in the sound wave communication method may vary based on a type of a service to which the sound wave communication is applied.

As an example, sound wave communication used for a coupon service may use at least 34 bits. Intervals between frequency posts corresponding to the bits may be 50 Hz.

As another example, sound wave communication used for an attendance check service may use at least 20 bits. Intervals between frequency posts corresponding to the bits may be 100 Hz.

As another example, sound wave communication used for a marketing service may use at least 20 bits. Intervals between frequency posts corresponding to the bits may be 100 Hz.

As another example, sound wave communication used for an entry management service may use 34 bits to 48 bits. Intervals between frequency posts corresponding to the bits may be 50 Hz.

When compared to the coupon service or the entry management service, the attendance check service or the marketing service may require a relatively small amount of data and thus, a relatively small number of bits may be used. Also, an interval between the frequency posts used for the attendance check service or the marketing service may be set to be wider in comparison to the coupon service or the entry management service, which may increase accuracy of long-distance sound wave communication.

The sound wave processing device 1310, the sound wave receiving device 1320, and the external server may be called differently based on a service type.

As an example, when the sound wave communication is applied to the coupon service, the sound wave processing device 1310 may be referred to as a coupon provider terminal and the sound wave receiving device 1320 may be referred to as a buyer terminal. When the external server is additionally used in the sound wave communication, the external server may be referred to as a coupon server.

As another example, when the sound wave communication is applied to the attendance check service, the sound wave processing device 1310 may be referred to as an examiner terminal and the sound wave receiving device 1320 may be referred to as a respondent terminal. When the external server is additionally used in the sound wave communication, the external server may be referred to as an attendance check server.

As another example, when the sound wave communication is applied to the marketing service, the sound wave processing device 1310 may be referred to as an advertisement transmitting terminal and the sound wave receiving device 1320 may be referred to as a user terminal. When the external server is additionally used in the sound wave communication, the external server may be referred to as an advertising company server.

As another example, when the sound wave communication is applied to the entry management service, the sound wave processing device 1310 may be referred to as a user terminal and the sound wave receiving device 1320 may be referred to as a door-lock device. When the external server is additionally used in the sound wave communication, the external server may be referred to as a security management server.

<Sound Wave Communication Scheme for Large Amount of Data>

Because the sound wave communication uses a limited frequency band, it may be difficult to encode a large amount of source data in which a number of bits exceeds a threshold, for example, 64 bits, to a single sound wave signal to be output. Thus, when source data has a large amount, the source data may be divided into a plurality of sound wave signals for encoding. In terms of a sound wave protocol for encoding the sound wave signal, the large amount of source data may be encoded based on a sound wave protocol different from those for general source data to acquire information such as a transmission order and a number of sound wave signals.

The sound wave processing device 1310 may divide the large amount of source data into n items of partial data based on the set sound wave protocol. The partial data may be one of items of source data into which the large amount of source data is divided to have a general number of bits. N may be determined to be a number by which the number of bits included in the large amount of source data is divided to be a maximum number of bits to be included in a body. For example, when a large quantity of sound wave data includes 96 bits and the maximum number of bits to be included in a body is 24, N may be determined to be 4. When the number of bits included in the partial data is less than the maximum number of bits included in the body, a residual body bit that does not correspond to a bit of the partial data may be set to be “null” or a combination of “1” or “0” indicating blank data.

Before the N items of partial data are transmitted and after all the N items of partial data are transmitted, the sound wave processing device 1310 may encode dummy data in which both the body and the error correction code are set as the blank data, to a sound wave signal and output the encoded sound wave signal. Using the dummy data together with the partial data, the sound wave processing device 1310 and the sound wave receiving device 1320 may easily determine an initiation and a termination of transmission of the large amount of source data. Here, the blank data may indicate that both the body and the error correction code are “null” or may be set as a combination of bits, for example, all bits processed as “0”, for indicating the blank data.

According to the sound wave protocol for transmitting the large amount of source data, the partial data may include at least two bits indicating type information, four bits indicating sequence information, the error correction code, and the body. In addition, the partial data may further include a start bit (beacon start) and an end bit (beacon end) indicating a start and an end of the sound wave signal at a head and a tail of a bit sequence.

The two bits indicating the type information may indicate information on a transmission start, a transmission in progress, and a transmission end of the sound wave signal to which the partial data is encoded. Specifically, when transmission of the sound wave signal to which the partial data is encoded is initiated, the type information may be set to “00”. When the transmission of the sound wave signal to which the partial data is encoded is in progress, the type information may be set to “01”. When the transmission of the sound wave signal to which the partial data is terminated, the type information may be set to “10”. The partial data of which the type information is set to “00” or “10” may be set as bits “null” corresponding to the error correction code and the body or set as a combination of bits “0” or “1” indicating blank data.

The four bits indicating the sequence information may indicate information on a total number of items of partial data and a serial number of the partial data.

As an example, in a case in which the dummy data is transmitted when transmitting the partial data, the number of transmitted items of partial data may be acquired by referencing the sequence information of the dummy data.

As another example, in a case in which the dummy data is not transmitted when transmitting the partial data, the number of items of transmitted partial data may be acquired by referencing sequence information of partial data transmitted last or largest sequence information.

The sequence information may be determined based on the type information. For example, when the type information is set to “00” or “10” indicating the start or the end of the sound wave signal to which the partial data is encoded, the sequence information may be set to be a value indicating the total number of items of partial data to be transmitted. When the total number is 4, the sequence information may be set to “0100”. When the type information is set to “01” indicating transmission of the sound wave signal to which the partial data is encoded, the sequence information may be set to be a value indicating a serial number of the sound wave signal to be transmitted. In a case of a third sound wave signal among sound wave signals having a total number of 4, the sequence information may be set to “0011”. The sequence information may be used for determining the number of items of partitioned data. The sound wave receiving device 1320 may determine the total number of items of partitioned data using sequence information of partitioned data transmitted last or largest sequence information among a plurality of items of partitioned data on which transmission is terminated.

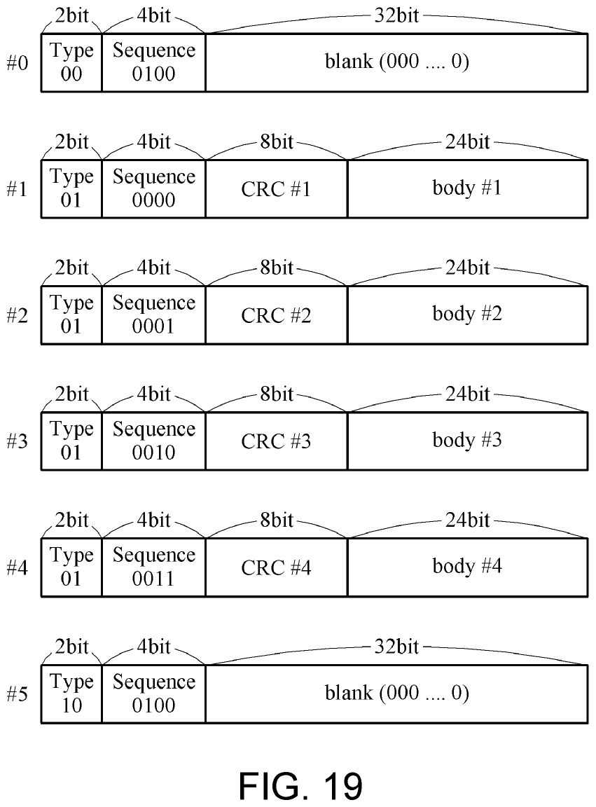

FIG. 19 illustrates an example of a sound wave protocol for transmitting a large amount of source data according to an example embodiment.

Referring to FIG. 19, when source data to be encoded is a large amount of data including 96 bits and N is 4, the sound wave processing device 1310 may divide the large amount of source data including the 96 bits into four items of partial data, each having a body including 24 bits. The sound wave processing device 1310 may encode the four divided partial data #1 to #4 and two dummy data #0 and #5 positioned before and after the partial data, to a sound wave signal and output the encoded sound wave signal. The sound wave protocol of FIG. 7 may include type information including two bits, sequence information including four bits, information on a body including 24 bits and an error correction code (CRC) including eight bits.

Type information of the dummy data #0 may be set to “00” to indicate a transmission start. Since the type information is set to “00” indicating the transmission start, sequence information may be represented as 4 (“0100”), a total number of items of partial data to be transmitted. Also all the 32 bits corresponding to the error correction code and the body may be set to “0” to indicate blank data.

Type information of the partial data #1 may be set to “01” to indicate a transmission in progress. Since the type information is set to “01” indicating the transmission in progress, sequence information may be set to “0000” corresponding to a serial number #1 of a sequence which is being transmitted currently. Also, the partial data #1 may include the error correction code including the eight bits and the body including the 24 bits.

Type information of the partial data #2 may be set to “01” to indicate the transmission in progress. Since the type information is set to “01” indicating the transmission in progress, sequence information may be set to “0001” corresponding to a serial number #2 of a sequence which is being transmitted currently. Also, the partial data #2 may include the error correction code including the eight bits and the body including the 24 bits.

Type information of the partial data #3 may be set to “01” to indicate the transmission in progress. Since the type information is set to “01” indicating the transmission in progress, sequence information may be set to “0010” corresponding to a serial number #3 of a sequence which is being transmitted currently. Also, the partial data #3 may include the error correction code including the eight bits and the body including the 24 bits.

Type information of the partial data #4 may be set to “01” to indicate the transmission in progress. Since the type information is set to “01” indicating the transmission in progress, sequence information may be set to “0011” corresponding to a serial number #4 of a sequence which is being transmitted currently. Also, the partial data #4 may include the error correction code including the eight bits and the body including the 24 bits.

Type information of the dummy data #5 may be set to “00” to indicate a transmission end. Since the type information is set to “00” indicating the transmission end, sequence information may be represented as “0100” which is the total number of items of partial data to be transmitted. Also all the 32 bits corresponding to the error correction code and the body may be set to “0” to indicate blank data.

In another example which is not shown, when a large amount of source data includes 96 bits and N is 6, the sound wave processing device 1310 may divide the large amount of source data into six items of partial data, each having a body including 16 bits. For example, when the divided partial data follows the sound wave protocol of FIG. 7, the maximum number of bits to be included in the body may be 24 and the number of bits included in the partial data is 16. Thus, eight bits of the body may be set as blank data.

In another example which is not shown, when a large amount of source data includes 37 bits and N is 3, the number of bits in the large amount of source data may not be divided by N. In this example, the large amount of source data may be divided into partial data including a body having the number of bits divided by N. Also, remaining bits may be included in the last partial data. For example, when the divided partial data follows the sound wave protocol of FIG. 19, the maximum number of bits to be included in the body may be 24 and the number of bits included in the partial data may be 10 (=37/3). Thus, in the body included in the partial data, 14 bits may be set as blank data. The sound wave processing device 1310 may generate one more additional partial data to process seven remaining bits. In a body of the generated partial data, 17 (=24−7) bits may be set as blank data.

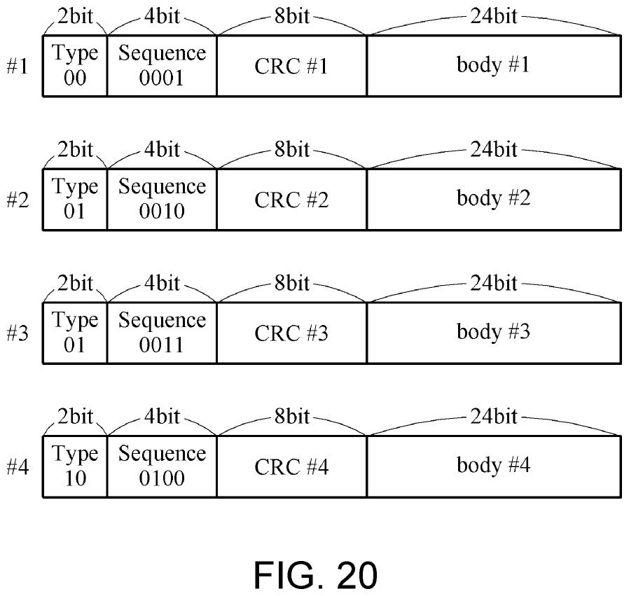

FIG. 20 is a block diagram illustrating another example of a sound wave protocol for transmitting a large amount of source data according to an example embodiment.

Referring to FIG. 20, the sound wave processing device 1310 may transmit partial data without dummy data when transmitting a large amount of source data. In this case, since separate dummy data indicating a transmission start and a transmission end of the partial data is absent, the transmission of the partial data may be initiated through transmission of partial data including a body and terminated through transmission of partial data including a last body. According to a sound wave protocol of FIG. 20, partial data may include type information including two bits, sequence information including four bits, and information on a body including 24 bits and an error correction code including eight bits.

Type information of partial data #1 may be set to “00” to indicate a transmission start. Sequence information may be set to “0001” corresponding to a serial number #1 of a sequence which is being transmitted currently. Also, the partial data #1 may include the error correction code including the eight bits and the body including the 24 bits.

Type information of partial data #2 may be set to “01” to indicate the transmission in progress. Sequence information may be set to “0010” corresponding to a serial number #2 of a sequence which is being transmitted currently. Also, the partial data #2 may include the error correction code including the eight bits and the body including the 24 bits.

Type information of partial data #3 may be set to “01” to indicate the transmission in progress. Sequence information may be set to “0011” corresponding to a serial number #3 of a sequence which is being transmitted currently. Also, the partial data #3 may include the error correction code including the eight bits and the body including the 24 bits.

Type information of the partial data #4 may be set to “10” to indicate a transmission end. Sequence information may be set to “0100” corresponding to a serial number #4 of a sequence which is being transmitted currently. Also, the partial data #4 may include the error correction code including the eight bits and the body including the 24 bits.

<Output of Sound Wave Signal>

As the foregoing, generation of source data for sound wave communication and shuffling thereof may be performed by the sound wave processing device 1310 and, depending on an example, may be performed by an external server. In this case, the external server may generate source data and process the source data by arranging bits included in the source data based on a shuffle array, so that the sound wave processing device 1310 receives the processed source data from the external server and encodes the source data to a sound wave signal.

When the external server generates source data and process the source data by arranging bits thereof, the sound wave processing device 1310 and the sound wave receiving device 1320 may not retain shuffle array information. When the sound wave processing device 1310 generates the sound wave signal, the sound wave processing device 1310 may not receive the sound wave signal, for example, a way file from the external server. As such, the sound wave processing device 1310 may receive data required for generating a sound wave signal from the external server and autonomously generate a sound wave signal corresponding to the data.

In one example, the sound wave processing device 1310 may generate a sound wave signal based on information required for generating the sound wave signal in response to the information being received from the external server. The information required for generating the sound wave signal may include at least shuffle data for shuffling bits included in a body and an error correction code, a frequency post interval, a position of a starting frequency, a sampling rate, and an amplitude of generated sound wave tone. The sampling rage may be a number of samplings per unit time, for example, a second obtained from a continuous signal to generate a discrete. A unit of the sampling rate may be Hz. The sampling rate may also be referred to as a sampling frequency.

In another example, data received by the sound wave processing device 1310 from the external server may be data on which the external server has performed shuffling. In this case, the sound wave processing device 1310 may generate sound wave tones in frequency posts corresponding to bits included in the data directly without need to shuffle the data, and generate a multi-tone sound wave signal through an aggregation of the sound wave tones.

As described with reference to <Method of generating sound wave signal for sound wave communication> of FIG. 14, the sound wave processing device 1310 may set frequency posts of m bits for a frequency band determined based on service type information, generate a sound wave tone of an amplitude based on the service type information for the frequency post corresponding to each of the m bits, and generate a multi-tone sound wave signal through an aggregation of the sound wave tones. The service type information may refer to information on one of service types including a coupon, an attendance check, marketing, and an entry management.

FIG. 21 illustrates an example of a sound wave communication method additionally using an external server according to an example embodiment.

An external server 2100 may correspond to the service server 110

The sound wave processing device 1310 may correspond to the terminal 120 and the sound wave receiving device 1320 may correspond to the terminal 130. Alternatively, the sound wave processing device 1310 may correspond to the terminal 130 and the sound wave receiving device 1320 may correspond to the terminal 120.

Referring to FIG. 21, in operation S200, the sound wave processing device 1310 may request source data from the external server 2100.

In operation S210, the external server 2100 may generate source data, process the source data by arranging m bits included in the source data based on a shuffle array, and encode the source data to a sound wave signal (for example, way-type data). Specifically, the external server 2100 may set m frequency posts corresponding to the m bits included in the source data processed based on the service type information, generate a sound wave tone having a predetermined amplitude for each of the m the frequency posts, and generate a multi-tone sound wave signal through an aggregation of the sound wave tones. As such, in a case of sound wave communication additionally using the external server 2100, the sound wave processing device 1310 may output the sound wave signal received from the external server 2100 and not have post array information corresponding to the m frequency posts or a shuffle array for restoring the m bits included in the processed source data to be in a state of before the arrangement.

The external server 2100 may transmit the sound wave signal to the sound wave processing device 1310 based on an electronic signal.

In operation S220, the external server 2100 may transmit the encoded sound wave signal to the sound wave processing device 1310.

In operation S230, the sound wave processing device 1310 may output the sound wave signal.

In operation S240, the sound wave receiving device 1320 may decode the sound wave signal received from the sound wave processing device 1310.

In operation S240, the sound wave receiving device 1320 may transmit the processed source data obtained by decoding the sound wave signal to the external server 2100.

In a case of sound wave communication additionally using the external server 2100, the sound wave receiving device 1320 may decode the sound wave signal received from the sound wave processing device 1310 and not have post array information corresponding to the m frequency posts or a shuffle array for restoring the m bits included in the processed source data to be in a state of before the arrangement. Thus, the sound wave receiving device 1320 may transmit the processed source data obtained by decoding the sound wave signal to the external server 2100, so that the external server 2100 restores the processed source data to a value of before shuffling.

In operation S250, the external server 2100 may transmit, to the sound wave receiving device 1320, source data obtained by restoring positions of the m bits before arrangement using the shuffle array to be in a state of before the processing.

FIG. 22 illustrates another example of a sound wave communication method additionally using an external server according to an example embodiment.

Referring to FIG. 22, in operation S300, the sound wave processing device 1310 may request source data from the external server 2100.

In operation S310, the external server 2100 may generate source data, process the source data by arranging m bits included in the source data based on a shuffle array, and encode the source data to a sound wave signal.

As such, in a case of sound wave communication additionally using the external server 2100, the sound wave processing device 1310 may output the sound wave signal received from the external server 2100 and not have post array information corresponding to the m frequency posts or a shuffle array for restoring the m bits included in the processed source data to be in a state of before the arrangement.

The method of transmitting the sound wave signal encoded by the external server 2100 to the sound wave processing device 1310 is described with reference to FIG. 21. Depending on an example, as illustrated in FIG. 22, the external server 2100 may encode processed source data to a sound wave signal and transmit indication information associated with the sound wave signal and the encoding to the sound wave processing device 1310, so that sound wave communication is performed using the sound wave signal output by the sound wave processing device 1310 based on the indication information.

In operation S320, the external server 2100 may transmit indication information associated with the encoded sound wave signal, for example, a URL link to the sound wave processing device 1310.

In operation S330, the sound wave processing device 1310 may acquire the sound wave signal based on the indication information.

In operation S340, the sound wave processing device 1310 may output the acquired sound wave signal.

In operation S350, the sound wave receiving device 1320 may decode the received sound wave signal.

In operation S360, the sound wave receiving device 1320 may transmit processed source data obtained by decoding the sound wave signal to an external server.

In a case of sound wave communication additionally using the external server 2100, the sound wave receiving device 1320 may decode the sound wave signal received from the sound wave processing device 1310 and not have post array information corresponding to the m frequency posts or a shuffle array for restoring the m bits included in the processed source data to be in a state of before the arrangement. Thus, the sound wave receiving device 1320 may transmit the processed source data obtained by decoding the sound wave signal to the external server 2100, so that the external server 2100 restores the processed source data to a value before shuffling.

In operation S370, the external server 2100 may transmit, to the sound wave receiving device 1320, source data obtained by restoring positions of the m bits of before arrangement using the shuffle array to be in a state of before the processing.

As such, when the indication information is used, since an amount of sound wave-related information transmitted from the external server 2100 to the sound wave processing device 1310 is relatively small, a large amount of source data may be transmitted through the sound wave communication.

<Sound Wave Processing Device>

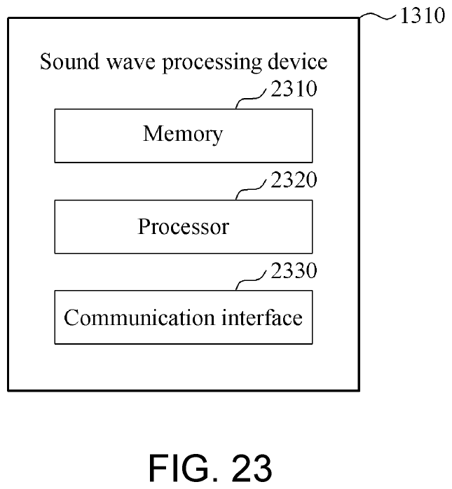

FIG. 23 is a block diagram illustrating the sound wave processing device 1310. Referring to FIG. 23, the sound wave processing device 1310 may include a memory in which a control program is recorded, a processor that operates based on the control program, and a communication interface that transmits and receives information to and from the external server 2100. The control program is executed to process source data by arranging m bits included in the source data based on a shuffle array used as a security code by the sound wave processing device, encode the processed source data to a sound wave signal, and output the encoded sound wave signal. When encoding the processed source data, the sound wave processing device sets m frequency posts corresponding to the m bits based on service type information, generates a sound wave tone having a predetermined amplitude for each of the m frequency posts, and generates a multi-tone sound wave signal through an aggregation of the sound wave tone.

A position of an initial frequency post among the m frequency posts may be set based on the service type information. Also, to enhance security, a frequency interval between the m frequency posts may be uniform or non-uniform. The sound wave processing device 1310 may change a shuffle array used for shuffling m the bits included in the source data at preset time intervals, for example, three hours, a day, and a week. In such configuration, even if the shuffle array is leaked, when a predetermined time elapses, an access to the source data may be denied using the leaked shuffle array and thus, security of sound wave communication may be enhanced. In a case of sound wave communication in which the external server 2100 is additionally used, the shuffle array may be changed by the external server 2100.

The sound wave processing device 1310 may generate a sound wave tone in a frequency post corresponding to a bit “1” of the source data. The source data may include a body and an error correction code. The sound wave processing device 1310 may arrange frequency posts in which remaining (m−2) bits of the m bits excluding a start bit and an end bit are located, based on the shuffle array. The source data may further include a time code associated with a time at which the sound wave signal is generated. The time code may be information for determining whether the sound wave signal is valid.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. An operation method of a service server, the method comprising:
transmitting a security key to a terminal and receiving payload data and symbol request data including service type information from another terminal;
generating a symbol corresponding to the other terminal based on a size determined based on the service type information;
generating mapping information in which the payload data and the generated symbol are mapped, with respect to the other terminal;
generating sound wave data for outputting a sound wave of the other terminal based on the generated symbol;
transmitting the generated sound wave data to the other terminal;
receiving, from the terminal, payload request data and a sound wave recognition result generated based on a sound wave and the security key, wherein the sound wave is output by the other terminal based on sound wave data received from the service server;
verifying whether the sound wave recognition result matches the generated symbol; and
transmitting, in response to the matching, the payload data to the terminal based on the mapping information.

2. The operation method of claim 1, wherein the generated sound wave data includes the generated symbol and an error correction code.

3. The operation method of claim 2, wherein an arrangement of bits of the generated symbol and the error correction code are changed based on the security key.

4. The operation method of claim 1, further comprising:
setting a frequency post of each of bits of the generated sound wave data based on at least one of frequency interval information and starting frequency information.

5. The operation method of claim 4, wherein the frequency interval information and the starting frequency information are associated with the service type information.

6. The operation method of claim 1, wherein when the sound wave data is generated, the operation method further comprises:
setting a frequency post of each of bits of the generated sound wave data;
generating a sound wave tone for a frequency post having a bit value of 1 among the bits; and
generating a multi-tone sound wave through an aggregation of the generated sound wave tone and generating a playback file in which the multi-tone sound wave is recorded.

7. The operation method of claim 1, further comprising:
verifying a validity of the sound wave recognition result by verifying whether the sound wave recognition result is received within a predetermined time from a point in time at which the symbol is generated.

8. The operation method of claim 1, wherein the payload data includes at least one of uniform resource locator (URL) information, a text, a static image, and a dynamic image.

9. A communication method using a sound wave signal, the method comprising:
processing, by a sound wave processing device, source data by arranging m bits included in the source data based on a shuffle array used as a security code;
encoding the processed source data to a sound wave signal; and
outputting the encoded sound wave signal,
wherein the encoding comprises:
setting m frequency posts corresponding to the m bits based on service type information and generating a sound wave tone having a predetermined amplitude for each of the m frequency posts; and
generating a multi-tone sound wave signal through an aggregation of the sound wave tone.

10. The communication method of claim 9, wherein a position of an initial frequency post among the m frequency posts is set based on the service type information.

11. The communication method of claim 9, wherein a minimum frequency interval between the m frequency posts is differently set based on the service type information.

12. The communication method of claim 9, wherein a frequency interval between the m frequency posts is uniform.

13. The communication method of claim 9, wherein a frequency interval between the m frequency posts is non-uniform.

14. The communication method of claim 9, wherein the sound wave tone is generated in the frequency post corresponding to a bit “1” of the source data.

15. The communication method of claim 9, wherein the source data includes a body and an error correction code.

16. The communication method of claim 15, wherein the source data further comprises a time code associated with a time in which the sound wave signal is generated and
the time code is information for determining whether the sound wave signal is valid.

17. A sound wave processing device comprising:
a memory in which a control program is recorded;
a processor configured to operate based on the control program; and
a communication interface configured to transmit and receive information to and from an external server,
wherein the control program is executed to perform:
processing source data by arranging m bits included in the source data based on a shuffle array used as a security code by the sound wave processing device;
encoding the processed source data to a sound wave signal; and
outputting the encoded sound wave signal, and
wherein the encoding comprises:
setting m frequency posts corresponding to the m bits based on service type information and generating a sound wave tone having a predetermined amplitude for each of the m frequency posts; and
generating a multi-tone sound wave signal through an aggregation of the sound wave tone.

18. The sound wave processing device of claim 17, wherein a position of an initial frequency post among the m frequency posts is set based on the service type information.

19. The sound wave processing device of claim 17, wherein a minimum frequency interval between the m frequency posts is differently set based on the service type information.

20. The sound wave processing device of claim 17, wherein the sound wave tone is generated in the frequency post corresponding to a bit “1” of the source data.
